(19) United States
(12) Patent Application Publication
(10) Pub. No.: US 2024/0045173 A1
(43) Pub. Date: Feb. 8, 2024

(54) OPTICAL IMAGING SYSTEM

(71) Applicant: Samsung Electro-Mechanics Co., Ltd., Suwon-si (KR)

(72) Inventors: Phil Ho JUNG, Suwon-si (KR); Yong Joo JO, Suwon-si (KR); Tae Yeon LIM, Suwon-si (KR)

(73) Assignee: Samsung Electro-Mechanics Co., Ltd., Suwon-si (KR)

(21) Appl. No.: 18/200,070

(22) Filed: May 22, 2023

(30) Foreign Application Priority Data
Aug. 8, 2022 (KR) 10-2022-0098764

(51) Int. Cl. G02B 9/12; G02B 13/00

(52) U.S. Cl. CPC G02B 9/12; G02B 13/0045; G02B 13/0065

(57) ABSTRACT

An optical imaging system includes a first lens group including at least one lens; a second lens group including at least one lens; and a third lens group including at least one lens, wherein the first lens group, the second lens group, and the third lens group are sequentially disposed in ascending numerical order along an optical axis from an object side toward an image side, each of the second lens group and the third lens group is configured to move along the optical axis relative to the first lens group, the at least one lens of the second lens group includes at least one glass lens and at least one plastic lens, an Abbe number of a glass lens of the second lens group is vg2_g, an Abbe number of a plastic lens of the second lens group is vg2_p, and |vg2_g−vg2_p| is greater than 25.

### CROSS-REFERENCE TO RELATED APPLICATIONS

This application claims the benefit under 35 USC 119(a) of Korean Patent Application No. 10-2022-0098764 filed on Aug. 8, 2022, in the Korean Intellectual Property Office, the entire disclosure of which is incorporated herein by reference for all purposes.

### BACKGROUND

### 1. Field

The present disclosure relates to an optical imaging system.

### 2. Description of Related Art

Recently, a plurality of cameras have commonly been installed in a mobile device. When a camera having a fixed magnification is used, an object in the distance may be enlarged by digital zoom to see the object in detail. However, in this case, a deterioration of an image quality may become an issue.

Since a camera module to be installed in a mobile device should have a reduced thickness, the shape of the lens may be non-axisymmetric (e.g., a D-cut shape) rather than a circular shape. However, generally, since only a portion of a circular lens may be used, there may be an issue in a resolving power of a plastic lens. That is, as circular symmetry of the lens is broken, an image quality of the lens may be deteriorated.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group including at least one lens; a second lens group including at least one lens; and a third lens group including at least one lens, wherein the first lens group, the second lens group, and the third lens group are sequentially disposed in ascending numerical order along an optical axis of the optical imaging system from an object side of the optical imaging system toward an image plane of the optical imaging system, each of the second lens group and the third lens group is configured to move along the optical axis relative to the first lens group, the at least one lens of the second lens group includes at least one glass lens and at least one plastic lens, and an Abbe number of a glass lens of the at least one glass lens of the second lens group is vg2_g, an Abbe number of a plastic lens of the at least one plastic lens of the second lens group is vg2_p, and |vg2)g−vg2_p| is greater than 25.

Each plastic lens of the at least one plastic lens of the second lens group may be an aspherical lens, and each glass lens of the at least one glass lens of the second lens group may be a spherical lens.

Each lens of the first to third lens groups may have a length in a first axial direction perpendicular to the optical axis, and a length in a second axial direction perpendicular to both the optical axis and the first axial direction that is longer than the length in the first axial direction.

The optical imaging system may further include an optical path changing element P disposed on an object side of the first lens group and configured to change a path of light passing through the optical imaging system.

An effective focal length of the optical imaging system at a telephoto end of the optical imaging system may be EFL_T, an effective focal length of the optical imaging system at a wide-angle end of the optical imaging system may be EFL_W, and EFL_W/EFL_T may be less than 0.7.

The at least one lens of the second lens group may be a plurality of lenses, an Abbe number of a lens closest to the object side of the optical imaging system among the plurality of lenses of the second lens group may be vg2_1, and vg2_1 may be greater than 55.

A spacing distance on the optical axis between the first lens group and the second lens group at a wide-angle end of the optical imaging system may be D12_W, a spacing distance on the optical axis between the first lens group and the second lens group at a telephoto end of the optical imaging system may be D12_T, and D12_T/D12_W may be less than 0.3.

A field of view at a telephoto end of the optical imaging system may be FOV_T, a field of view at a wide-angle end of the optical imaging system may be FOV_W, and FOV_W/FOV_T may be greater than 1.6.

A focal length of the second lens group may be fg2, a focal length of the third lens group may be fg3, and fg2/fg3 may be greater than −0.8.

An F number of the optical imaging system at a telephoto end of the optical imaging system may be Fno_T, a field of view of the optical imaging system at a telephoto end of the optical imaging system may be FOV_T, and Fno T/FOV_T may be less than 0.5 (1/°).

The at least one lens of the first lens group may include at least one glass lens and at least one plastic lens, the at least one lens of the third lens group may include at least one plastic lens, an effective radius of a glass lens having a largest effective radius among the glass lenses of the first and second lens groups may be MAX_GED, an effective radius of a plastic lens having a smallest effective radius among the plastic lenses of the first to third lens groups may be MIN_PED, and MAX_GED/MIN_PED may be greater than 1 and less than 1.7.

The at least one lens of the first lens group may include at least one glass lens and at least one plastic lens, an effective radius of a glass lens having a largest effective radius among the glass lenses of the first and second lens groups may be MAX_GED, one half of a diagonal length of the image plane of the optical imaging system may be IMG HT, and MAX_GED/IMG HT may be greater than 1 and less than 1.4.

The optical imaging system may further include a stop disposed between the first lens group and the second lens group.

The at least one lens of the second lens group may be a plurality of lenses, and a lens disposed closest to the stop among the plurality of lenses of the second lens group may have an effective radius that is larger than an effective radius of each other lens of the first to third lens groups.

The first lens group may have a negative refractive power, the second lens group may have a positive refractive power, and the third lens group may have a negative refractive power.

The at least one lens of the second lens group may be a plurality of lenses, and among the plurality of lenses of the second lens group, a lens closest to the object side of the optical imaging system may have a positive refractive power.

The at least one lens of the third lens group may include a lens having a positive refractive power disposed closest to the object side of the optical imaging system among the plurality of lenses of the third lens group, and a lens having a negative refractive power disposed closest to the image side of the optical imaging system among the plurality of lenses of the third lens group.

In another general aspect, an optical imaging system includes a first lens group including a plurality of lenses and having a negative refractive power; a second lens group including a plurality of lenses and having a positive refractive power; and a third lens group including a plurality of lenses and having a negative refractive power, wherein the first lens group, the second lens group, and the third lens group are sequentially disposed in ascending numerical order along an optical axis of the optical imaging system from an object side of the optical imaging system toward an image side of the optical imaging system, each of the second lens group and the third lens group is configured to move along the optical axis relative to the first lens group, the optical imaging system may further include a stop disposed between the first lens group and the second lens group, the at least one lens of the second lens group includes at least one glass lens and at least one plastic lens, and a glass lens of the at least one glass lens of the second lens group has a length in a first axial direction perpendicular to the optical axis, and a length in a second axial direction perpendicular to both the optical axis and the first axial direction that is longer than the length in the first axial direction.

An Abbe number of a glass lens of the at least one glass lens of the second lens group may be vg2_g, an Abbe number of a plastic lens of the at least one plastic lens of the second lens group may be vg2_p, and |vg2_g−vg2_p| may be greater than 25 and less than 35.

The at least one lens of the first lens group may include at least one glass lens and at least one plastic lens.

An Abbe number of a glass lens of the at least one glass lens of the first lens group may be vg1_g, an Abbe number of a plastic lens of the at least one plastic lens of the first lens group may be vg1_p, and |vg1_g−vg1_p| may be greater than 30.

Other features and aspects will be apparent from the following detailed description, the drawings, and the claims.

### BRIEF DESCRIPTION OF DRAWINGS

FIG. 1 is a cross-sectional diagram illustrating an optical imaging system at a wide-angle end according to a first embodiment of the present disclosure.

FIG. 2 is a cross-sectional diagram illustrating the optical imaging system at a telephoto end according to the first embodiment of the present disclosure.

FIG. 3 is graphs illustrating aberration properties of the optical imaging system at the wide-angle end according to the first embodiment of the present disclosure.

FIG. 4 is graphs illustrating aberration properties of the optical imaging system at the telephoto end according to the first embodiment of the present disclosure.

FIG. 5 is a cross-sectional diagram illustrating an optical imaging system at a wide-angle end according to the second embodiment of the present disclosure.

FIG. 6 is a cross-sectional diagram illustrating the optical imaging system at a telephoto end according to the second embodiment of the present disclosure.

FIG. 7 is graphs illustrating aberration properties of the optical imaging system at the wide-angle end according to the second embodiment of the present disclosure.

FIG. 8 is graphs illustrating aberration properties of the optical imaging system at the telephoto end according to the second embodiment of the present disclosure.

FIG. 9 is a cross-sectional diagram illustrating an optical imaging system at a wide-angle end according to a third embodiment of the present disclosure.

FIG. 10 is a cross-sectional diagram illustrating the optical imaging system at a telephoto end according to the third embodiment of the present disclosure.

FIG. 11 is graphs illustrating aberration properties of the optical imaging system at the wide-angle end according to the third embodiment of the present disclosure.

FIG. 12 is graphs illustrating aberration properties of the optical imaging system at the telephoto end according to the third embodiment of the present disclosure.

FIG. 13 is a cross-sectional diagram illustrating an optical imaging system at a wide-angle end according to a fourth embodiment of the present disclosure.

FIG. 14 is a cross-sectional diagram illustrating the optical imaging system at a telephoto end according to the fourth embodiment of the present disclosure.

FIG. 15 is graphs illustrating aberration properties of the optical imaging system at the wide-angle end according to the fourth embodiment of the present disclosure.

FIG. 16 is graphs illustrating aberration properties of the optical imaging system at the telephoto end according to the fourth embodiment of the present disclosure.

FIG. 17 is a cross-sectional diagram illustrating an optical imaging system at a wide-angle end according to a fifth embodiment of the present disclosure.

FIG. 18 is a cross-sectional diagram illustrating the optical imaging system at a telephoto end according to the fifth embodiment of the present disclosure.

FIG. 19 is graphs illustrating aberration properties of the optical imaging system at the wide-angle end according to the fifth embodiment of the present disclosure.

FIG. 20 is graphs illustrating aberration properties of the optical imaging system at the telephoto end according to the fifth embodiment of the present disclosure.

FIG. 21 is a cross-sectional diagram illustrating the optical imaging system according to the first embodiment viewed in a long axis direction of one or more lenses having a D-cut shape.

FIG. 22 is a diagram illustrating a lens having a D-cut shape according to an embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the embodiments, the X direction, the Y direction, and the Z direction may be directions parallel to the X-axis, the Y-axis, and the Z-axis, respectively, illustrated in the drawings. Also, unless otherwise indicated, the X-direction may include both the +X-axis direction and the −X-axis direction. This also applies to the Y-direction and the Z-direction.

In the embodiments, a configuration in which two directions (or axes) are parallel or perpendicular to each other may include a configuration in which the two directions (or axes) are almost parallel or substantially parallel to each other. For example, a configuration in which the first axis and the second axis are perpendicular to each other may indicate that the first axis and the second axis form an angle of 90 degrees or substantially 90 degrees.

Paragraphs beginning with “in an embodiment” may not necessarily indicate the same embodiment. The particular features, structures, or characteristics may be combined in any suitable manner consistent with the present disclosure.

In the embodiments, “configured to” indicates that a component has a structure necessary to implement a predetermined function.

In describing the configuration of each lens, an image side may indicate, for example, a direction in which an image plane on which an image is formed is disposed or a direction in which an image sensor is disposed, and an object side may indicate a direction in which an object is disposed. Also, an “object-side surface” of the lens may refer to, for example, a lens surface on the side on which an object is disposed with respect to an optical axis, and an “image-side surface” may refer to a lens surface on the side on which an image plane is disposed with respect to the optical axis. The image plane may be, for example, an imaging device surface or an image sensor surface. The image sensor may include, for example, a sensor such as a complementary metal-oxide-semiconductor (CMOS) device or a charge-coupled device (CCD). The image sensor is not limited thereto, and may be, for example, any device configured to convert an image of an object into an electrical image signal.

Unless stated otherwise, a reference to a shape of a lens surface refers to a shape of a paraxial region of the lens surface. A paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

For example, a statement that an object-side surface of a lens is convex means that at least a paraxial region of the object-side surface of the lens is convex, and a statement that an image-side surface of the lens is concave means that at least a paraxial region of the image-side surface of the lens is concave. Therefore, even though the object-side surface of the lens may be described as being convex, the entire object-side surface of the lens may not be convex, and a peripheral region of the object-side surface of the lens may be concave. Also, even though the image-side surface of the lens may be described as being concave, the entire image-side surface of the lens may not be concave, and a peripheral region of the image-side surface of the lens may be convex.

### 1. Common Elements (Embodiments 1 to 5)

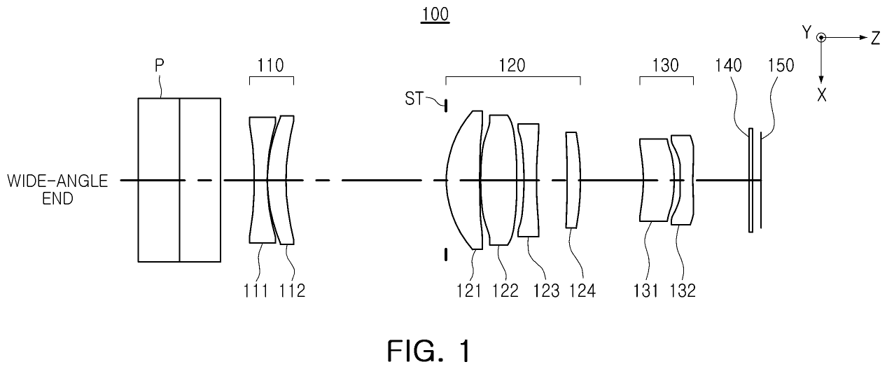

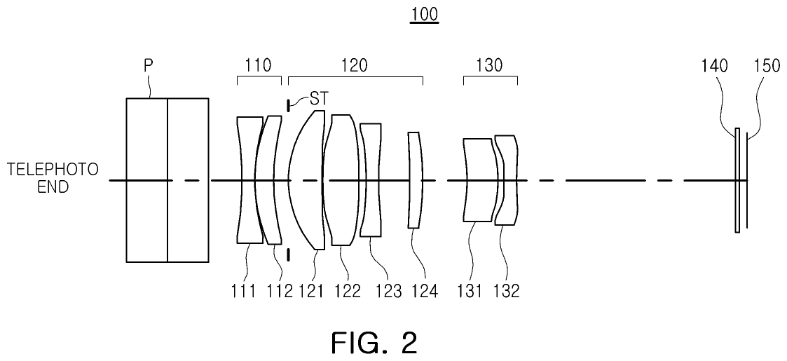

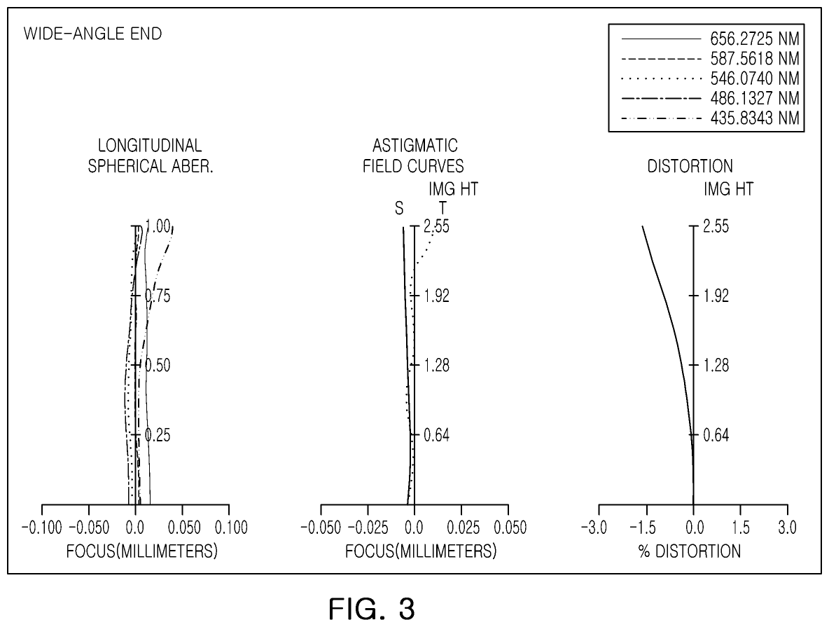

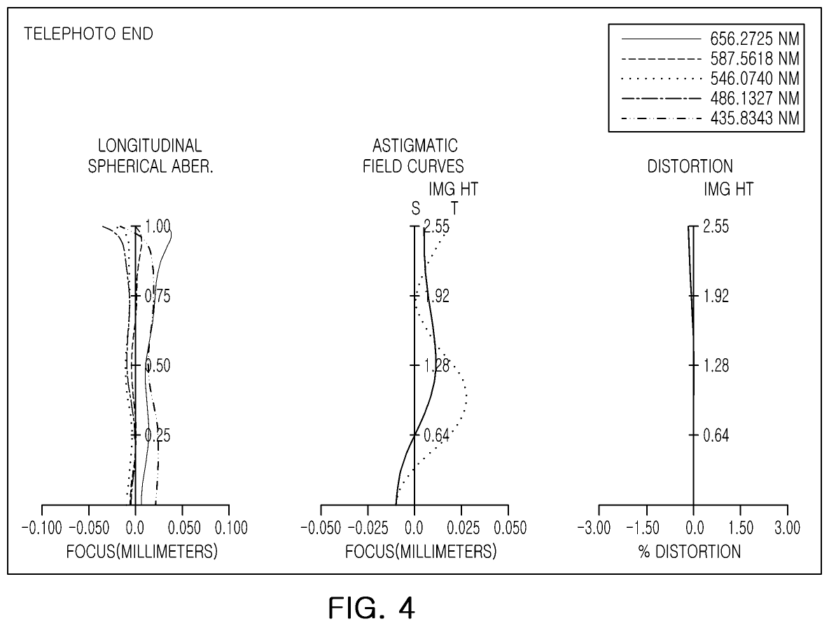

FIG. 1 is a cross-sectional diagram illustrating an optical imaging system at a wide-angle end according to a first embodiment. FIG. 2 is a cross-sectional diagram illustrating the optical imaging system at a telephoto end according to the first embodiment. FIG. 3 is graphs illustrating aberration properties of the optical imaging system at the wide-angle end according to the first embodiment. FIG. 4 is graphs illustrating aberration properties of the optical imaging system at the telephoto end according to the first embodiment.

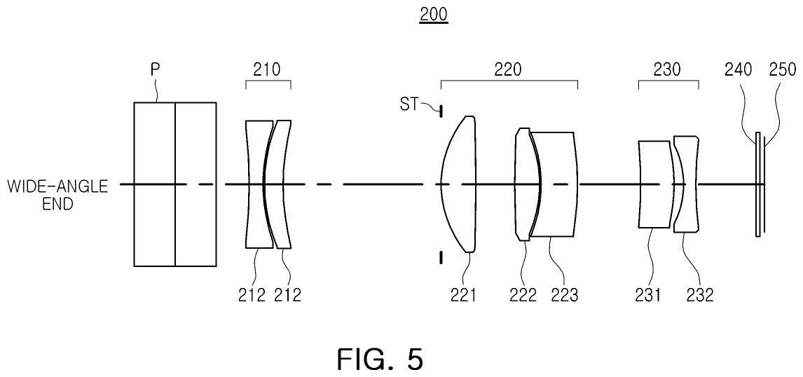

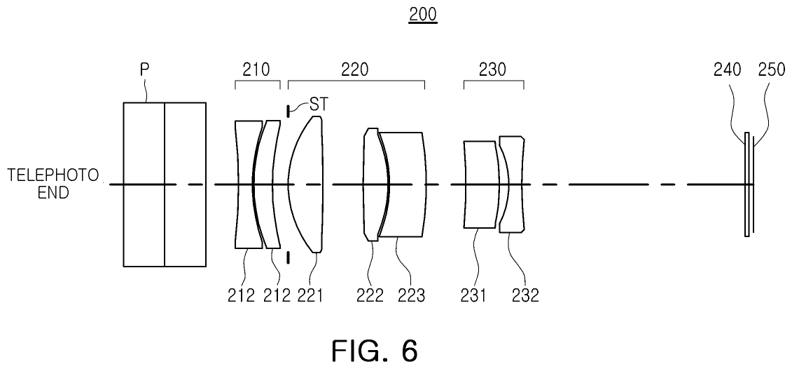

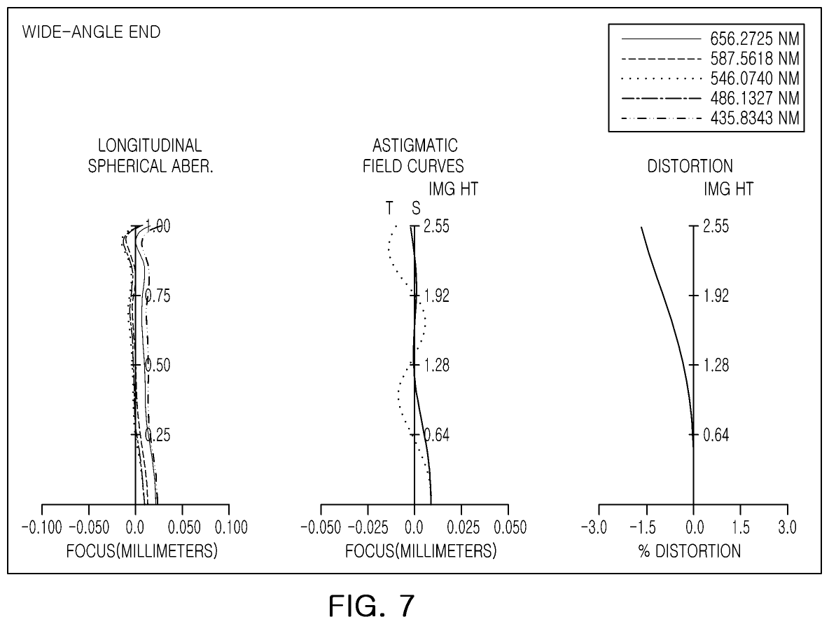

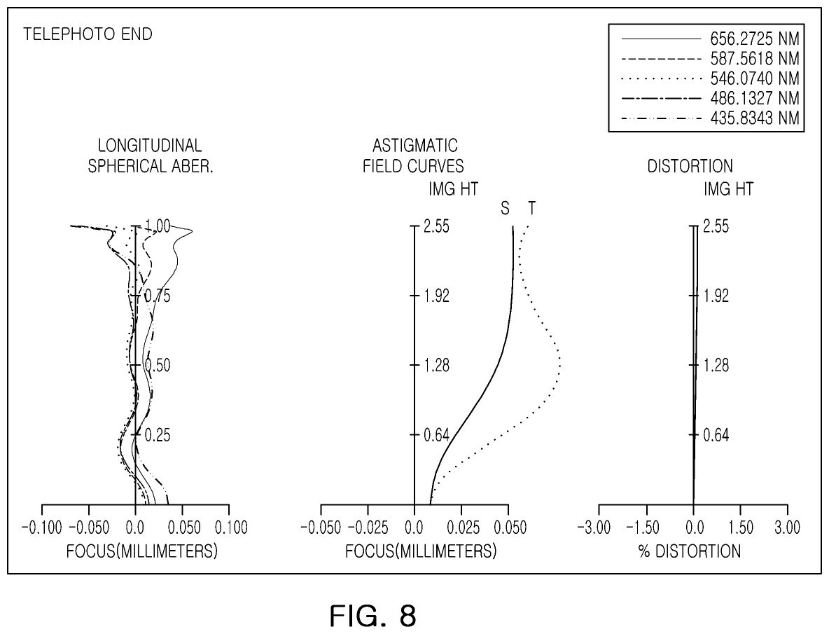

FIG. 5 is a cross-sectional diagram illustrating an optical imaging system at a wide-angle end according to a second embodiment. FIG. 6 is a cross-sectional diagram illustrating the optical imaging system at a telephoto end according to the second embodiment. FIG. 7 is graphs illustrating aberration properties of the optical imaging system at the wide-angle end according to the second embodiment. FIG. 8 is graphs illustrating aberration properties of the optical imaging system at the telephoto end according to the second embodiment.

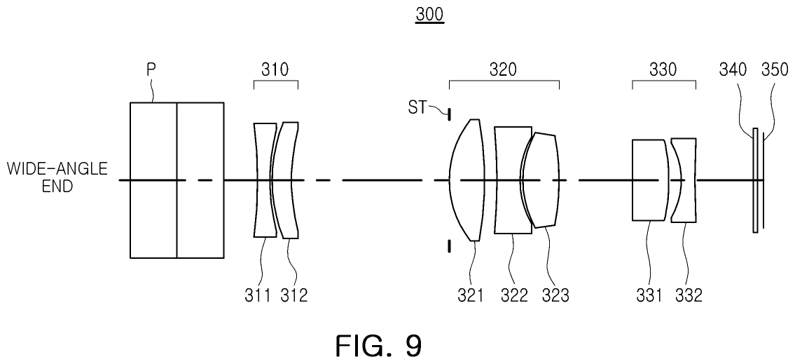

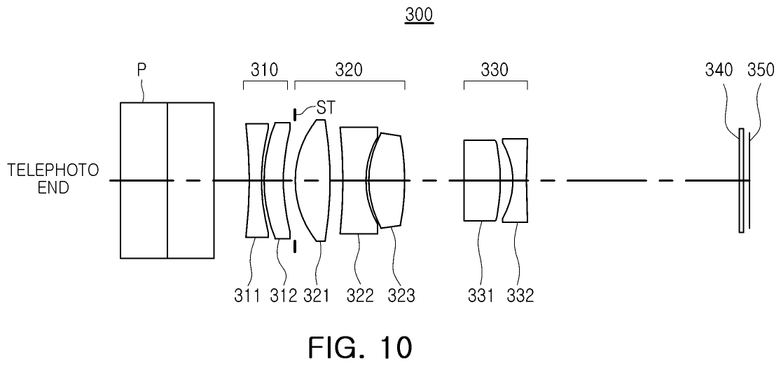

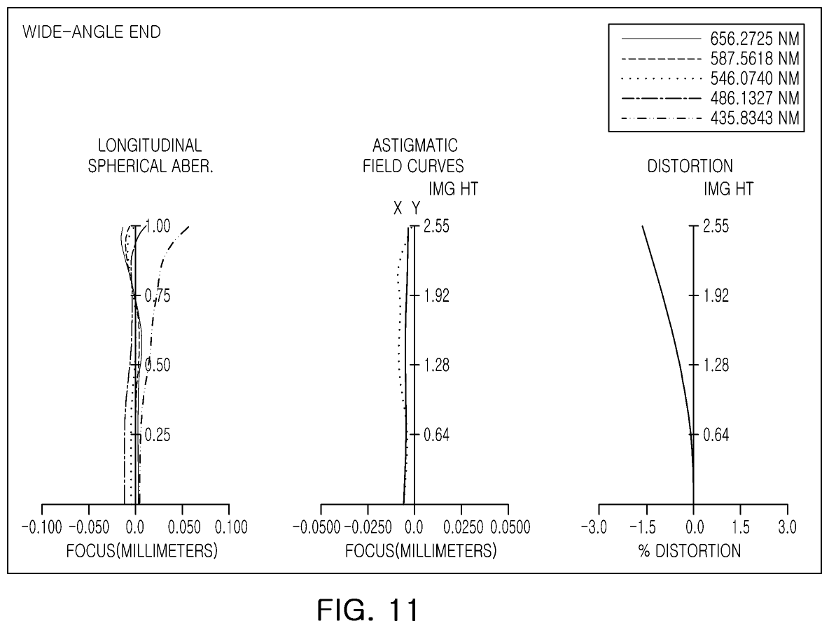

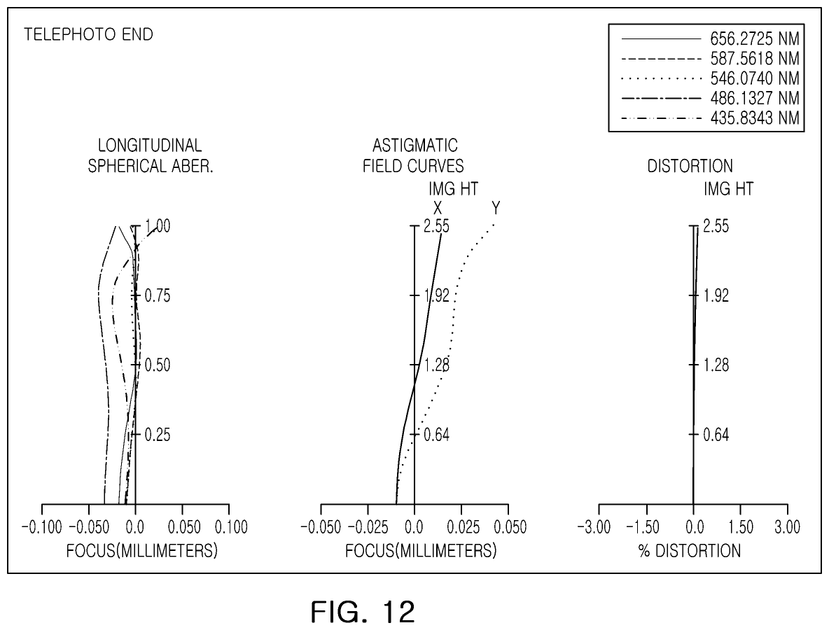

FIG. 9 is a cross-sectional diagram illustrating an optical imaging system at a wide-angle end according to a third embodiment. FIG. 10 is a cross-sectional diagram illustrating the optical imaging system at a telephoto end according to the third embodiment. FIG. 11 is graphs illustrating aberration properties of the optical imaging system at the wide-angle end according to the third embodiment. FIG. 12 is graphs illustrating aberration properties of the optical imaging system at the telephoto end according to the third embodiment.

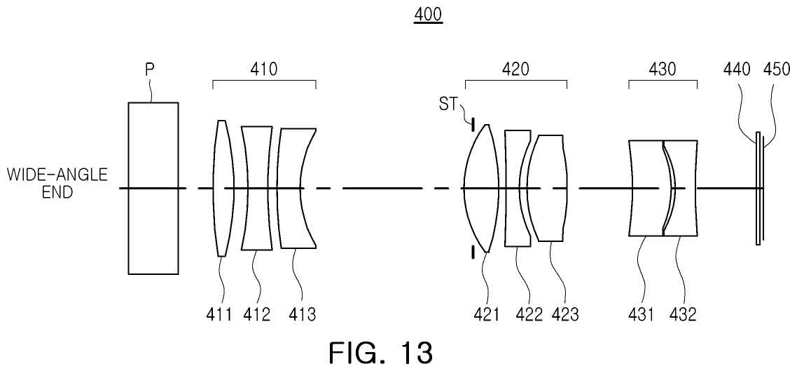

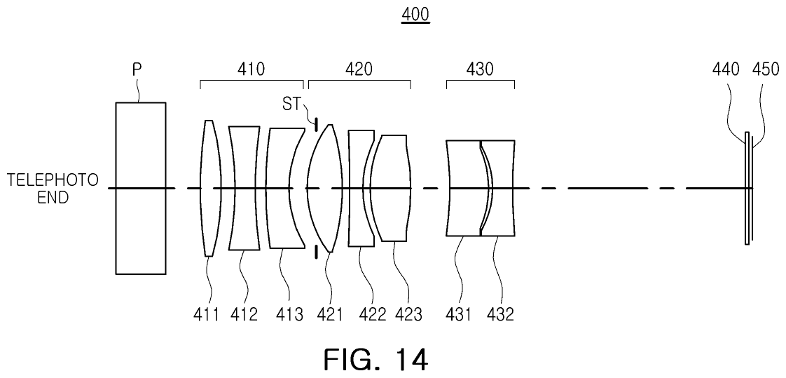

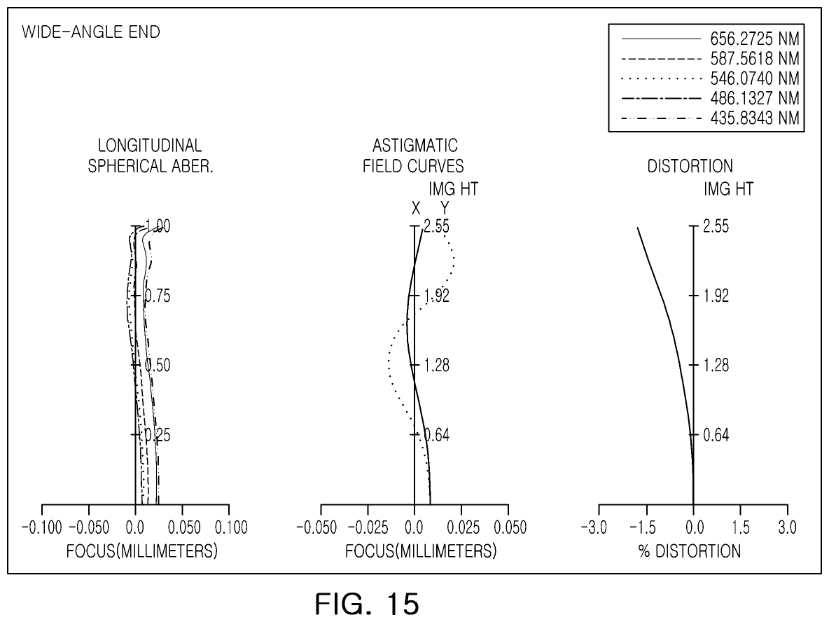

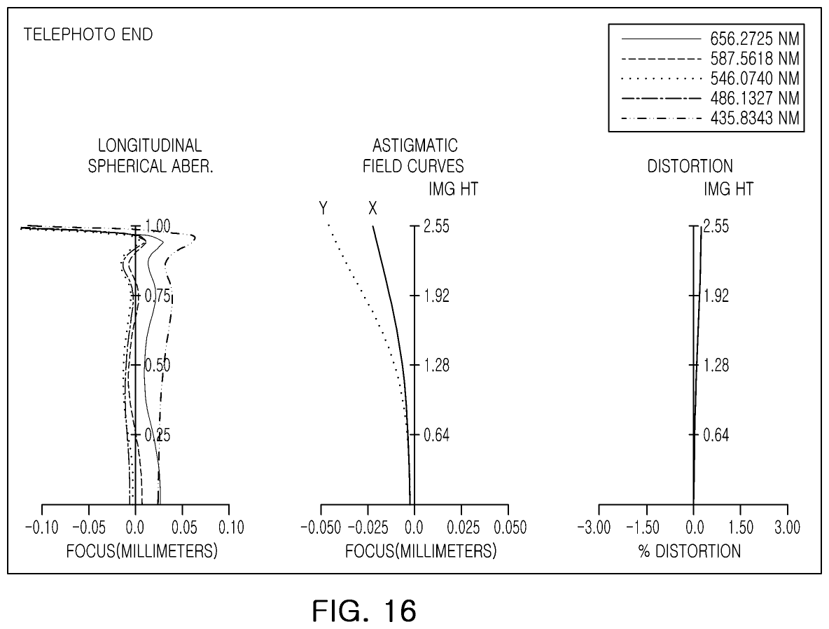

FIG. 13 is a cross-sectional diagram illustrating an optical imaging system ata wide-angle end according to a fourth embodiment. FIG. 14 is a cross-sectional diagram illustrating the optical imaging system at a telephoto end according to the fourth embodiment. FIG. 15 is graphs illustrating aberration properties of the optical imaging system at the wide-angle end according to the fourth embodiment. FIG. 16 is graphs illustrating aberration properties of the optical imaging system at the telephoto end according to the fourth embodiment.

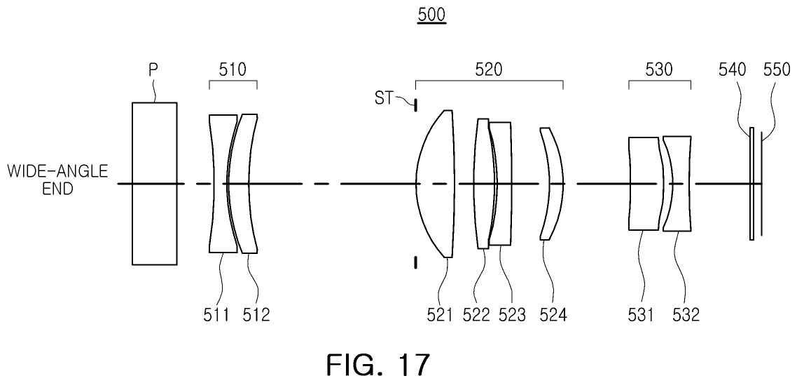

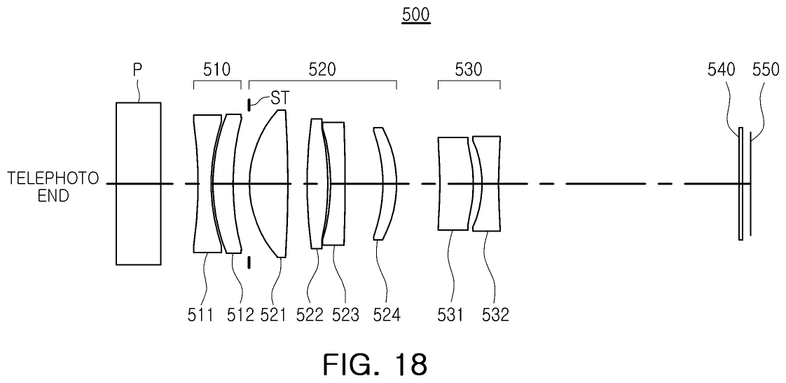

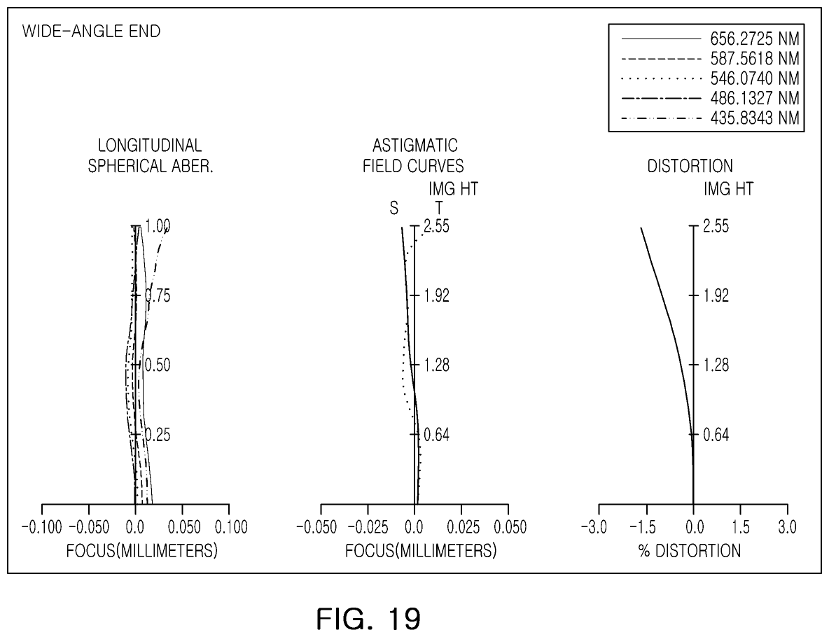

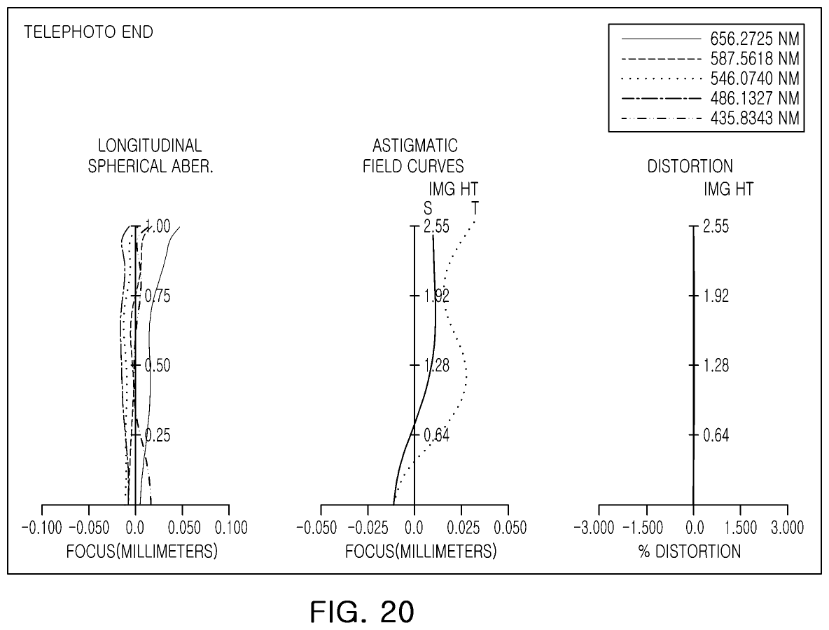

FIG. 17 is a cross-sectional diagram illustrating an optical imaging system at a wide-angle end according to a fifth embodiment. FIG. 18 is a cross-sectional diagram illustrating the optical imaging system oat a telephoto end according to the fifth embodiment. FIG. 19 is graphs illustrating aberration properties of the optical imaging system at the wide-angle end according to the fifth embodiment. FIG. 20 is graphs illustrating aberration properties of the optical imaging system at the telephoto end according to the fifth embodiment.

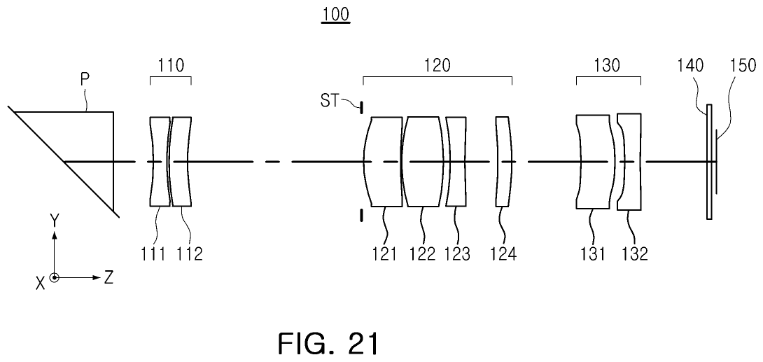

FIG. 21 is a cross-sectional diagram illustrating an optical imaging system according to the first embodiment viewed in a long axis direction of one or more lenses having a D-cut shape.

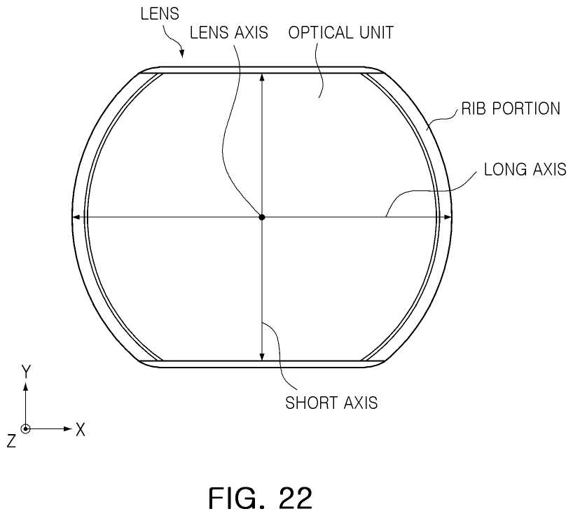

FIG. 22 is a diagram illustrating a lens having a D-cut shape according to an embodiment.

Hereinafter, optical imaging systems 100, 200, 300, 400, and 500 according to the first to fifth embodiments will be described with reference to FIGS. 1 to 20.

The optical imaging systems 100, 200, 300, 400, and 500 may include three lens groups and an image sensor 150, 250, 350, 450, and 550. In an embodiment, the optical imaging systems 100, 200, 300, 400, and 500 may include a first lens group 110, 210, 310, 410, and 510, a second lens group 120, 220, 320, 420, and 520, a third lens group 130, 230, 330, 430, and 530, and the image sensor 150, 250, 350, 450, and 550 sequentially arranged in the order listed from an object side of the optical imaging systems 100, 200, 300, 400, and 500 toward an image plane of the optical imaging systems 100, 200, 300, 400, and 500.

Each of the lens groups may include at least one lens having a refractive power. In the embodiments, unless otherwise indicated, a lens may refer to a lens having a refractive power.

When the lens group includes two or more lenses, the lenses included in the corresponding lens group may move together while being fixed relative to each other. For example, the configuration in which the second lens group 120 moves in the optical axis direction in the optical imaging system 100 according to the first embodiment may indicate that the lenses 121, 122, 123, and 124 included in the second lens group 120 may move in the direction of the optical axis while maintaining fixed distances therebetween.

Some or all of the lens groups may move in the optical axis direction, and accordingly the magnification or focus of the optical imaging systems 100, 200, 300, 400, and 500 may be adjusted. For example, the second lens groups 120, 220, 320, 420, and 520 and the third lens groups 130, 230, 330, 430, and 530 may independently move in the optical axis direction. The magnification (e.g., between 4× and 10×) may be adjusted as the second lens group 120, 220, 320, 420, and 520 moves along the optical axis, and to compensate for this change and to adjust the focus, the third lens group 130, 230, 330, 430, and 530 may move along the optical axis.

The optical imaging systems 100, 200, 300, 400, and 500 may further include an optical path folding element P on the object side of the first lens group 110, 210, 310, 410, and 510. The optical path changing element P may be an optical element configured to change a traveling direction of light, and may include, for example, a prism or a mirror.

In the drawings, the optical imaging systems 100, 200, 300, 400, and 500 may include the optical path changing element P, but this is only an example, and in each embodiment, the optical path changing element P may not be provided. For example, the optical path changing element P in the optical imaging system 100 in FIG. 1 may not be provided.

In the drawings, light may be incident to the optical path changing element P in a direction substantially perpendicular to the ground, and may be reflected by approximately 90 degrees by the optical path changing element P and may be directed toward the lenses and the image sensor.

The optical imaging systems 100, 200, 300, 400, and 500 may include an IR-cut filter 140, 240, 340, 440, and 540 disposed between the lens closest to the image sensor 150, 250, 350, 450, and 550 and the image sensor 150, 250, 350, 450, and 550. The IR-cut filter 140, 240, 340, 440, and 540 may be made of, for example, a glass material. However, a different material may be used. In another embodiment, the IR-cut filter 140, 240, 340, 440, and 540 may not be provided.

The first lens group 110, 210, 310, 410, and 510 may have a negative refractive power, the second lens group 120, 220, 320, 420, and 520 may have a positive refractive power, and the third lens group 130, 230, 330, 430, and 530 may have a negative refractive power.

Among the lenses included in the second lens group 120, 220, 320, 420, and 520, the lenses 121, 221, 321, 421, and 521 closest to the object side may have a positive refractive power. For example, in the optical imaging system 100 according to the first embodiment, the third lens 121 may have a positive refractive power. As another example, in the optical imaging system 400 according to the fourth embodiment, the fourth lens 421 may have a positive refractive power.

The third lens group 130, 230, 330, 430, and 530 may include lenses having refractive having opposite signs. Among the two lenses included in the third lens group 130, 230, 330, 430, and 530, a lens adjacent to the object side may have a positive refractive power, and the lens closest to the image side may have a negative refractive power. For example, in the optical imaging system 100 according to the first embodiment, the third lens group 130 may include a seventh lens 131 having a positive refractive power and an eighth lens 132 having a negative refractive power.

Among the lenses included in the first lens group 110, 210, 310, 410, and 510, the lenses 112, 212, 312, 413, and 512 closest to the second lens group 120, 220, 320, 420, and 520 (or closest to the image side) may have a meniscus shape convex toward the object side. For example, in the optical imaging system 100 according to the first embodiment, the object-side surface of the second lens 112 may be convex and the image-side surface may be concave.

Among the lenses included in the second lens group 120, 220, 320, 420, and 520, the object-side surfaces of the lenses 121, 221, 321, 421, and 521 closest to the first lens group 110, 210, 310, 410, and 510 (or closest to the object side) may be convex. For example, in the optical imaging system 100 according to the first embodiment, the object-side surface of the third lens 121 may be convex.

Among the lenses included in the second lens group 120, 220, 320, 420, and 520, the image-side surfaces of the lenses 124, 223, 323, 423, and 524 closest to the third lens group 130, 230, 330, 430, and 530 (or closest to the image side) may be convex. For example, in the optical imaging system 100 according to the first embodiment, the image-side surface of the sixth lens 124 may be convex.

The third lens group 130, 230, 330, 430, and 530 may include lenses having refractive powers having opposite signs. In an embodiment, the lenses 131, 231, 331, 431 and 531 adjacent to the object side among the two lenses included in the third lens group 130, 230, 330, 430, and 530 may have a meniscus shape convex toward the image side. In an embodiment, both surfaces of the lenses 132, 232, 332, 432, and 532 adjacent to the image side among the two lenses included in the third lens group 130, 230, 330, 430, and 530 may be concave.

The optical imaging systems 100, 200, 300, 400, and 500 may include at least one aspherical lens. In an embodiment, either one or both of the object-side surface and the image-side surface of at least one of the lenses included in the optical imaging systems 100, 200, 300, 400 and 500 may be aspherical. In an embodiment, at least one of the three lens groups included in the optical imaging systems 100, 200, 300, 400, and 500 may include at least one lens of which either one or both of an object-side surface and an image-side surface is aspherical. In the embodiments, an aspherical lens may refer to a lens of which either one or both of an object-side surface and an image-side surface thereof is aspherical.

A lens included in the optical imaging system according to an embodiment may have an aspherical surface. In an embodiment, the object-side surface and the image-side surface of the first lens, the fourth lens, and the sixth to eighth lenses may be aspherical surfaces. In another embodiment the object-side surface and the image-side surface of the first lens, the third lens, the fourth lens, the sixth lens, and the seventh lens may be aspherical surfaces. In another embodiment, the object-side surface and the image-side surface of the first lens, the third lens, and the fifth to seventh lenses may be aspherical surfaces. In another embodiment, the object-side surface and the image-side surface of the second to fourth lenses and the sixth to eighth lenses may be aspherical surfaces. The aspherical surfaces of the lenses may be represented by the following Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} \qquad ( 1 )$$

In Equation 1, c is a curvature of a lens surface at an optical axis of the lens, and is equal to a reciprocal of a radius of curvature of the lens surface at the optical axis, K is a conic constant, Y is a distance from any point on the lens surface to the optical axis in a direction perpendicular to the optical axis, A to H and J are aspheric coefficients, and Z (also known as sag) is a distance in a direction parallel to the optical axis from the point on the lens surface at the distance Y from the optical axis to a tangential plane perpendicular to the optical axis and intersecting a vertex of the lens surface at the optical axis.

The optical imaging systems 100, 200, 300, 400, and 500 may include a stop ST disposed between the first lens group 110, 210, 310, 410, and 510 and the second lens group 120, 220, 320, 420, and 520.

Also, in an embodiment, the lens disposed closest to the stop ST may have the largest effective diameter among the lenses.

For example, the stop ST may be disposed between the first lens group 110, 210, 310, 410, and 510 and the second lens group 120, 220, 320, 420, and 520, and the first lens of the second lens group 120, 220, 320, 420, and 520 may be disposed more adjacent to the stop ST than the lenses included in the first lens group 110, 210, 310, 410, and 510.

Among the lenses included in the second lens group 120, 220, 320, and 520, the lenses 121, 221, 321, and 521 closest to the stop ST may have an effective diameter larger than effective diameters of the other lenses included in the second lens group 120, 220, 320, and 520 and the lenses included in the first lens group 110, 210, 310, and 510 and the third lens group 130, 230, 330, and 530.

In various embodiments, some of the lenses may be made of a plastic material. In at least some of the embodiments, some of the lenses may be made of a plastic material by injection molding. In various embodiments, the optical path changing element P may be made of a glass material or a plastic material. However, other transparent optical materials may be used. Also, in an embodiment, different lenses may be made of materials having different optical properties, such as different Abbe numbers and/or different refractive indexes.

In an embodiment, one or more of the lenses may have a shape other than an axisymmetric shape (e.g., a circular shape), such as, for example an oval shape, a rectangular shape, a square shape, or a rectangular shape having rounded corners. In an embodiment, one or more of the lenses may have a D-cut shape. Referring to FIGS. 1, 21, and 22, one or more of the lenses of the optical imaging system 100 may have a D-cut shape. FIG. 1 is a diagram illustrating the optical imaging system 100 viewed in a short axis direction (the Y-axis direction) of the one or more lenses having the D-cut shape, and FIG. 21 is a diagram illustrating the optical imaging system 100 viewed in a long axis direction (the X-axis direction) of the one or more lenses having the D-cut shape. For example, one, some, or all of the lenses of the optical imaging system 100 may have a D-cut shape as illustrated in FIG. 22. The length of the one, some, or all of the lenses in the first axis (Y-axis) direction perpendicular to the optical axis (Z-axis) may be shorter than the length of the one, some, or all of the lenses in the second axis (X-axis) direction perpendicular to both the optical axis and the first axis (Y-axis) direction.

In this case, as compared to the example in which a lens has an axisymmetric shape (e.g., a circular shape), the length of the lens in one direction (the height in the Y-axis direction when the lens is viewed in the optical axis direction) may be reduced, which may contribute to reducing the height of the optical imaging system 100 in the one direction. The D-cut shape may include a shape formed by cutting a portion of an optical unit of a circular lens exhibiting an optical characteristic, and also a shape formed by cutting a portion of an area of the circular lens (e.g., a rib portion of the circular lens) other than the optical unit. The optical imaging systems 200, 300, 400, and 500 of the second to fifth embodiments may also include one or more lenses having the shape illustrated in FIG. 22.

To maintain an image quality above a predetermined level even in various environmental conditions, the optical imaging systems 100, 200, 300, 400, and 500 may need to have robustness against environmental changes. Although the manufacturing cost of a plastic lens may be lower than the manufacturing cost of a glass lens, an optical performance of the plastic lens may be greatly affected by changes in the surrounding environment (e.g., temperature or humidity) as compared to a glass lens.

By configuring the optical imaging systems 100, 200, 300, 400, and 500 by combining glass lenses and plastic lenses, the optical imaging systems 100, 200, 300, 400, and 500 may be manufactured at a low cost and may be resistant to changes in the surrounding environment (e.g., temperature or humidity). In an embodiment, the optical imaging systems 100, 200, 300, 400, and 500 may include at least one plastic lens and at least one glass lens.

Any one, any combination of any two or more, or all three of the first lens group 110, 210, 310, 410, and 510, the second lens group 120, 220, 320, 420, and 520, and the third lens group 130, 230, 330, 430, and 530 may include at least one plastic lens. In an embodiment, either one or both of the first lens group 110, 210, 310, 410, and 510 and the second lens group 120, 220, 320, 420, and 520 may include at least one glass lens and at least one plastic lens. For example, in the optical imaging system 100 according to the first embodiment, the second lens 112 of the first lens group 110 may be made of glass, and the first lens 111 of the first lens group 110 may be made of plastic. Also, the third lens 121 and the fifth lens 123 of the second lens group 120 may be made of glass, and the fourth lens 122 and the sixth lens 124 of the second lens group 120 may be made of plastic.

The third lens group 130, 230, 330, 430, and 530 may include only plastic lenses. For example, in the optical imaging system 100 according to the first embodiment, the seventh lens 131 and the eighth lens 132 of the third lens group 130 may be made of plastic.

The at least one plastic lens may be an aspherical lens, and the at least one glass lens may be a spherical lens. For example, in the optical imaging system 100 according to the first embodiment, the first lens 111, the fourth lens 122, the sixth lens 124, the seventh lens 131, and the eighth lens 132 made of plastic may be aspherical lenses, and the second lens 112, the third lens 121, and the fifth lens 123 made of glass may be spherical lenses.

Since the aspherical lenses included in the optical imaging systems 100, 300, 400, and 500 may be made of plastic, and the spherical lenses included in the optical imaging systems 100, 300, 400, and 500 may be made of glass, the manufacturing cost of the optical imaging systems 100, 300, 400, and 500 will be reduced. However, in at least one embodiment, either one or both of an object-side surface and an image-side surface of a glass lens may be aspherical.

For example, the optical imaging system 100 according to the first embodiment may include eight lenses 111, 112, 121, 122, 123, 124, 131, and 132 having a refractive power. The first lens 111, the fourth lens 122, the sixth lens 124, the seventh lens 131, and the eighth lens 121 may be aspherical lenses and may be made of plastic, and the second lens 122, the third lens 121, and the fifth lens 123 may be spherical lenses and may be made of glass. In another example, the optical imaging system 400 according to the fourth embodiment may include eight lenses 411, 412, 413, 421, 422, 423, 431, and 432 having a refractive power. The second lens 412, the third lens 413, the fourth lens 421, the sixth lens 423, the seventh lens 431, and the eighth lens 432 may be aspherical lenses and may be made of plastic, and the first lens 411 and the fifth lens 422 may be spherical lenses and may be made of glass.

The optical imaging systems 100, 200, 300, 400, and 500 may satisfy any one or any combination of any two or more of the following Conditional Expression 1 to Conditional Expression 10.

EFL_W/EFL_T<0.7 (Conditional Expression 1)

vg2_1>55 (Conditional Expression 2)

D12_T/D12_W<0.3 (Conditional Expression 3)

FOV_W/FOV_T>1.6 (Conditional Expression 4)

fg2/fg3>−0.8 (Conditional Expression 5)

Fno_T/FOV_T<0.5(1/°) (Conditional Expression 6)

|vg2_g−vg2_p|>25 (Conditional Expression 7)

|vg1_g−vg1_p|>30 (Conditional Expression 8)

1<MAX_GED/MIN_PED<1.7 (Conditional Expression 9)

1<MAX_GED/IMG HT<1.4 (Conditional Expression 10)

EFL_W is the effective focal length of the optical imaging system at the wide-angle end, and EFL_T is the effective focal length of the optical imaging system at the telephoto end.

vg2_1 is the Abbe number of the first lens of the second lens group 120, 220, 320, 420, and 520. For example, in the optical imaging systems 100, 200, 300, and 500 according to the first to third and fifth embodiments, vg2_1 is the Abbe number of the third lens, and in the optical imaging system according to the fourth embodiment, vg2_1 is the Abbe number of the fourth lens.

D12_W is the distance between the first lens group 110, 210, 310, 410, and 510 and the second lens group 120, 220, 320, 420, and 520 at the wide-angle end, and D12_T is the distance between the first lens group 110, 210, 310, 410, and 510 and the second lens group 120, 220, 320, 420, and 520 at the telephoto end.

FOV_W is a field of view at the wide-angle end, and FOV_T is a field of view at the telephoto end.

fg2 is the focal length of the second lens group 120, 220, 320, 420, and 520, and fg3 is the focal length of the third lens group 130, 230, 330, 430, and 530.

Fno_T is the F number at the telephoto end.

vg1_g is the Abbe number of the glass lens of the first lens group 110, 210, 310, 410, and 510, and vg1_p is the Abbe number of the plastic lens or each of the plastic lenses of the first lens group 110, 210, 310, 410 and 510.

vg2_g is the Abbe number of the glass lens or each of the glass lenses of the second lens group 120, 220, 320, 420, and 520, and vg2_p is the Abbe number of the plastic lens or each of the plastic lenses of the second lens group 120, 220, 320, 420, and 520.

MAX_GED is an effective radius of a lens having the largest effective radius among the glass lenses of the optical imaging systems 100, 200, 300, 400, and 500, and MIN_PED is an effective radius of a lens having the smallest effective radius among the plastic lenses of the optical imaging systems 100, 200, 300, 400, and 500.

IMG HT one half of a diagonal length of the image plane of the optical imaging systems 100, 200, 300, 400, and 500.

With respect to Conditional Expression 1, the optical imaging systems 100, 200, 300, 400, and 500 may be configured to satisfy EFL_W/EFL_T<0.5.

With respect to Conditional Expression 2, the optical imaging systems 100, 200, and 500 may be configured to satisfy vg2_1>70.

With respect to Conditional Expression 3, the optical imaging systems 100, 200, 300, 400, and 500 may be configured to satisfy 0.09<D12_T/D12_W<0.3.

With respect to Conditional Expression 4, the optical imaging systems 100, 200, 300, 400, and 500 may be configured to satisfy FOV_W/FOV_T>2.0.

With respect to Conditional Expression 5, the optical imaging systems 100, 200, 300, 400, and 500 may be configured to satisfy −0.8<fg2/fg3<0.0.

With respect to Conditional Expression 6, the optical imaging systems 100, 200, 300, 400, and 500 may be configured to satisfy 0.4<Fno_T/FOV_T<0.5(1/°).

With respect to Conditional Expression 7, when the second lens group 120, 220, 320, 420, and 520 includes a plurality of glass lenses or a plurality of plastic lenses, the conditional expressions may be satisfied with respect to all glass lenses and all plastic lenses. Also, the optical imaging systems 100, 200, 300, 400, and 500 may be configured to satisfy 25<|vg2_g−vg2_p|<35.

With respect to Conditional Expression 8, the optical imaging systems 100, 200, 300, and 500 may be configured to satisfy 30<|vg1_g−vg1_p|<35.

In an embodiment, the optical imaging system may include at least two glass lenses. At least one of the glass lenses may have an Abbe number of 70 or more and 85 or less, and at least one of the glass lenses may have an Abbe number of 28 or less. For example, in the optical imaging systems 100, 200, and 500 according to the first, second, and fifth embodiments, the Abbe numbers of the second lens 112, 212, and 512 and the fifth lens 123, 223, and 523 may be 23.8 or less, and the Abbe number of the third lens 121, 221, and 521 may be 80 or more.

In an embodiment, the optical imaging system may include at least two glass lenses. A difference between the Abbe numbers of two of the glass lenses may be 50 or more. For example, in the optical imaging systems 100, 200, and 500 according to the first, second, and fifth embodiments, the difference between the Abbe number of the second lens 112, 212, and 512 (or the fifth lens 123, 223, and 523) and the Abbe number of the third lens 121, 221, and 521 may be 57.8.

In an embodiment, each of the first lens group and the second lens group may include at least one glass lens, and a glass lens of the first lens group and a glass lens of the second lens group may be adjacent to each other. That is, a glass lens of the first lens group may be disposed closest to the image side among the lenses included in the first lens group, and a glass lens of the second lens group may be the lens closest to the object side among the lenses included in the second lens group. The difference between the Abbe numbers of the two lenses may be 50 or more. For example, in the optical imaging systems 100, 200, and 500 according to the first, second, and fifth embodiments, the second lens 112, 212, and 512 and the third lens 121, 221, and 521 may be glass lenses and may be adjacent to each other.

In an embodiment, the difference between the Abbe numbers of the two adjacent glass lenses may be 50 or more. For example, in the optical imaging systems 100, 200, and 500 according to the first, second, and fifth embodiments, the difference between the Abbe numbers of the second lenses 112, 212, and 512 and the third lenses 121, 221, and 521 may be 57.8.

In an embodiment, the first lens group may include two lenses, and a difference between the Abbe numbers of these two lenses may be 30 or more. In an embodiment, the first lens group may include a plastic lens and a glass lens, and the difference between the Abbe numbers of these lenses may be 30 or more. For example, in the optical imaging systems 100, 200, 300, and 500 according to the first, second, third, and fifth embodiments, the difference between the Abbe numbers of the first lenses 111, 211, 311, and 511 and the second lenses 112, 212, 312 and 512 may be 30 or more.

### 2. Embodiments 1 and 5

Hereinafter, the optical imaging systems 100 and 500 according to the first and fifth embodiments will be described with reference to FIGS. 1, 2, 17, and 18.

The optical imaging systems 100 and 500 may include three lens groups. The optical imaging systems 100 and 500 may include 8 lenses having a refractive power. For example, the first lens groups 110 and 510 may include the first lenses 111 and 511 and the second lenses 112 and 512, the second lens groups 120 and 520 may include the third to sixth lenses 121, 122, 123, 124, 521, 522, 523, and 524, and the third lens groups 130 and 530 may include the seventh lenses 131 and 531 and the eighth lenses 132 and 532. The second lens groups 120 and 520 and the third lens groups 130 and 530 may move along the optical axis in the optical axis direction. As the second lens groups 120 and 520 and the third lens groups 130 and 530 move along the optical axis, the magnification or focus of the optical imaging systems 100 and 500 may be adjusted.

The first lens groups 110 and 510 may have a negative refractive power, the second lens groups 120 and 520 may have a positive refractive power, and the third lens groups 130 and 530 may have a negative refractive power.

The first lenses 111 and 511 may have a negative refractive power. The object-side surfaces of the first lenses 111 and 511 may be concave in the paraxial region. The image-side surfaces of the first lenses 111 and 511 may be concave in the paraxial region. The object-side surfaces of the first lenses 111 and 511 may be aspherical. The image-side surfaces of the first lenses 111 and 511 may be aspherical.

The second lenses 112 and 512 may have a positive refractive power. The object-side surfaces of the second lenses 112 and 512 may be convex in the paraxial region. The image-side surfaces of the second lenses 112 and 512 may be concave in the paraxial region.

The third lenses 121 and 521 may have a positive refractive power. The object-side surfaces of the third lenses 121 and 521 may be convex in the paraxial region.

The fourth lenses 122 and 522 may have a positive refractive power. The object-side surfaces of the fourth lenses 122 and 522 may be convex in the paraxial region. The image-side surfaces of the fourth lenses 122 and 522 may be convex in the paraxial region. The object-side surfaces of the fourth lenses 122 and 522 may be aspherical. The image-side surfaces of the fourth lenses 122 and 522 may be aspherical.

The fifth lenses 123 and 523 may have a negative refractive power. The object-side surfaces of the fifth lenses 123 and 523 may be concave in the paraxial region.

The sixth lenses 124 and 524 may have a positive refractive power. The object-side surfaces of the sixth lenses 124 and 524 may be concave in the paraxial region. The image-side surfaces of the sixth lenses 124 and 524 may be convex in the paraxial region. The object-side surfaces of the sixth lenses 124 and 524 may be aspherical. The image-side surfaces of the sixth lenses 124 and 524 may be aspherical.

The seventh lenses 131 and 531 may have a positive refractive power. The object-side surfaces of the seventh lenses 131 and 531 may be concave in the paraxial region. The image-side surfaces of the seventh lenses 131 and 531 may be convex in the paraxial region. The object-side surfaces of the seventh lenses 131 and 531 may be aspherical. The image-side surfaces of the seventh lenses 131 and 531 may be aspherical.

The eighth lenses 132 and 532 may have a negative refractive power. The object-side surfaces of the eighth lenses 132 and 532 may be concave in the paraxial region. The image-side surfaces of the eighth lenses 132 and 532 may be concave in the paraxial region. The object-side surfaces of the eighth lenses 132 and 532 may be aspherical. The image-side surfaces of the eighth lenses 132 and 532 may be aspherical.

The lenses included in the optical imaging systems 100 and 500 may be made of plastic and glass. Since the optical imaging systems 100 and 500 include a combination of glass lenses and plastic lenses, the optical imaging systems 100 and 500 may be manufactured at a low cost and may be resistant to changes in the surrounding environment (e.g., temperature or humidity). At least one lens of the first lens group 110 and 510 may be made of glass. At least one lens of the second lens group 120 and 520 may be made of glass. For example, the second lenses 112 and 512, the third lenses 121 and 521, and the fifth lenses 123 and 523 may be made of glass, and the first lenses 111 and 511, the fourth lenses 122 and 522, the sixth lenses 124 and 524, the seventh lenses 131 and 531, and the eighth lenses 132 and 532 may be made of plastic.

### 3. Embodiments 2 and 3

Referring to the embodiments illustrated in FIGS. 5, 6, 9, and 10, in an embodiment, the optical imaging systems 200 and 300 may include three lens groups. The optical imaging system may include 7 lenses having a refractive power. The first lens groups 210 and 310 may include the first lenses 211 and 311 and the second lenses 212 and 322, the second lens groups 220 and 320 may include the third to fifth lenses 221, 222, 223, 321, 322, and 323, and the third lens groups 230 and 330 may include the sixth lenses 231 and 331 and the seventh lenses 232 and 332. The second lens groups 220 and 320 and the third lens groups 230 and 330 may move along the optical axis in the optical axis direction. As the second lens groups 220 and 320 and the third lens groups 230 and 330 move along the optical axis, the magnification or focus of the optical imaging system may be adjusted.

In an embodiment, the first lens groups 210 and 310 may have a negative refractive power, the second lens groups 220 and 320 may have a positive refractive power, and the third lens groups 230 and 330 may have a negative refractive power.

In an embodiment, the first lenses 211 and 311 may have a negative refractive power. The object-side surfaces of the first lenses 211 and 311 may be concave in the paraxial region. The image-side surfaces of the first lenses 211 and 311 may be concave in the paraxial region. The object-side surfaces of the first lenses 211 and 311 may be aspherical. The image-side surfaces of the first lenses 211 and 311 may be aspherical.

The second lenses 212 and 312 may have a positive refractive power. The object-side surfaces of the second lenses 212 and 312 may be convex in the paraxial region. The image-side surfaces of the second lenses 212 and 312 may be concave in the paraxial region.

The third lenses 221 and 321 may have a positive refractive power. The object-side surfaces of the third lenses 221 and 321 may be convex in the paraxial region. The image-side surfaces of the third lenses 221 and 321 may be convex in the paraxial region. The object-side surface of the third lens 321 may be aspherical. The image-side surface of the third lens 321 may be aspherical.

The image-side surfaces of the fifth lenses 223 and 323 may be convex in the paraxial region. The object-side surface of the fifth lens 323 may be aspherical. The image-side surface of the fifth lens 323 may be aspherical.

The sixth lenses 231 and 331 may have a positive refractive power. The object-side surfaces of the sixth lenses 231 and 331 may be concave in the paraxial region. The image-side surfaces of the sixth lenses 231 and 331 may be convex in the paraxial region. The object-side surfaces of the sixth lenses 231 and 331 may be aspherical. The image-side surfaces of the sixth lenses 231 and 331 may be aspherical.

The seventh lenses 232 and 332 may have a negative refractive power. The object-side surfaces of the seventh lenses 232 and 332 may be concave in the paraxial region. The image-side surfaces of the seventh lenses 232 and 332 may be concave in the paraxial region. The object-side surfaces of the seventh lenses 232 and 332 may be aspherical. The image-side surfaces of the seventh lenses 232 and 332 may be aspherical.

At least one lens of the first lens group 210 and 310 may be made of glass. For example, the second lenses 212 and 312 may be made of glass. At least one lens of the second lens group 220 and 320 may be made of glass. For example, in the optical imaging system 200 according to the second embodiment, the third lens 221 and the fifth lens 223 may be made of glass. In another example, in the optical imaging system 300 according to the third embodiment, the fourth lens 322 may be made of glass.

### 4. Specific Embodiments

### 4.1. Embodiment 1

Hereinafter, the optical imaging system 100 according to the first embodiment will be

described with reference to FIGS. 1 to 4.

In an embodiment, the optical imaging system 100 may include three lens groups. The first lens group 110 may include a first lens 111 and a second lens 112, the second lens group 120 may include third to sixth lenses 121, 122, 123 and 124, and the third lens group 130 may include a seventh lens 131 and an eighth lens 132. The second lens group 120 and the third lens group 130 may be configured to move along the optical axis in the optical axis direction. The magnification or focus of the optical imaging system 100 may be adjusted while the second lens group 120 and the third lens group 130 move along the optical axis.

The first lens group 110 may have a negative refractive power, the second lens group 120 may have a positive refractive power, and the third lens group 130 may have a negative refractive power. The focal length of the first lens group 110 may be −19.153 mm, the focal length of the second lens group 120 may be 8.789 mm, and the focal length of the third lens group 130 may be −15.749 mm.

The first lens 111 may have a negative refractive power. The object-side surface of the first lens 111 may be concave in the paraxial region. The image-side surface of the first lens 111 may be concave in the paraxial region. The object-side surface of the first lens 111 may be aspherical. The image-side surface of the first lens 111 may be aspherical. The first lens 111 may be made of plastic.

The second lens 112 may have a positive refractive power. The object-side surface of the second lens 112 may be convex in the paraxial region. The image-side surface of the second lens 112 may be concave in the paraxial region. The second lens 112 may be made of glass.

The third lens 121 may have a positive refractive power. The object-side surface of the third lens 121 may be convex in the paraxial region. The image-side surface of the third lens 121 may be concave in the paraxial region. The third lens 121 may be made of glass.

The fourth lens 122 may have a positive refractive power. The object-side surface of the fourth lens 122 may be convex in the paraxial region. The image-side surface of the fourth lens 122 may be convex in the paraxial region. The object-side surface of the fourth lens 122 may be aspherical. The image-side surface of the fourth lens 122 may be aspherical. The fourth lens 122 may be made of plastic.

The fifth lens 123 may have a negative refractive power. The object-side surface of the fifth lens 123 may be concave in the paraxial region. The image-side surface of the fifth lens 123 may be concave in the paraxial region. The fifth lens 123 may be made of glass.

The sixth lens 124 may have a positive refractive power. The object-side surface of the sixth lens 124 may be concave in the paraxial region. The image-side surface of the sixth lens 124 may be convex in the paraxial region. The object-side surface of the sixth lens 124 may be aspherical. The image-side surface of the sixth lens 124 may be aspherical. The sixth lens 124 may be made of plastic.

The seventh lens 131 may have a positive refractive power. The object-side surface of the seventh lens 131 may be concave in the paraxial region. The image-side surface of the seventh lens 131 may be convex in the paraxial region. The object-side surface of the seventh lens 131 may be aspherical. The image-side surface of the seventh lens 131 may be aspherical. The seventh lens 131 may be made of plastic.

The eighth lens 132 may have a negative refractive power. The object-side surface of the eighth lens 132 may be concave in the paraxial region. The image side of the eighth lens 132 may be concave in the paraxial region. The object-side surface of the eighth lens 132 may be aspherical. The image-side surface of the eighth lens 132 may be aspherical. The eighth lens 132 may be made of plastic.

Thus, the second lens 512, the third lens 521, and the fifth lens 523 may be made of glass, and the first lens 511, the fourth lens 522, the sixth lens 524, the seventh lens 531, and the eighth lens 532 may be made of plastic.

In the optical imaging system 100 according to the first embodiment, EFL_W/EFL_T may be 0.4195, vg2_1 may be 81.6, D12_T/D12_W may be 0.0924, FOV_W/FOV_T may be 2.3945, fg2/fg3 may be −0.5581, Fno_T/FOV_T may be 0.4037)(1/°), |vg2_g−vg2_p| may be 25.9 or 31.9,|vg1_g−vg1_p| may be 32.2, MAX_GED/MIN_PED may be 1.685, and MAX_GED/IMG HT may be 1.3216.

Table 1 lists the optical and physical parameters of the optical imaging system 100 according to the first embodiment. Table 2 lists aspheric coefficients in the first embodiment. Table 3 lists optical parameters at the wide-angle end and the telephoto end of the optical imaging system 100 according to the first embodiment. Table 12 lists the effective radius of each surface of each lens in the first embodiment.

In Table 3, EFL is an effective focal length of the optical imaging system, BFL (back focal length) is a distance on the optical axis between the image-side surface of the eighth lens 132 closest to the image plane and the image plane, and OAL (overall length) is a distance on the optical axis from the object-side surface of the optical path changing element P to the image plane.

TABLE 1

| | | | Thickness/Dis- | Thickness/Dis- | | |
|---|---|---|---|---|---|---|
| | | | tance (mm) | tance (mm) | | |
| Ele- | | | Wide-Angle | Telephoto | Refractive | Abbe |
| ment | Surface # | Ri (mm) | End | End | Index (Nd) | Number (Vi) |
| Prism | 1 | Infinity | 2.450 | 2.450 | 1.717 | 29.5 |
| | 2 | Infinity | 2.450 | 2.450 | 1.717 | 29.5 |
| | 3 | Infinity | 1.800 | 1.800 | | |
| First | 4 | −34.528 | 0.700 | 0.700 | 1.544 | 56 |
| Lens | 5 | 8.469 | 0.053 | 0.053 | | |
| Second | 6 | 9.142 | 1.000 | 1.000 | 1.847 | 23.8 |
| Lens | 7 | 13.003 | 8.663 | 0.800 | | |
| (Glass) | | | | | | |
| Third | 8 Stop | 5.669 | 1.777 | 1.777 | 1.497 | 81.6 |
| Lens | 9 | 31.117 | 0.050 | 0.050 | | |
| (Glass) | | | | | | |
| Fourth | 10 | 9.074 | 4.000 | 4.000 | 1.535 | 55.7 |
| Lens | 11 | −14.091 | 0.340 | 0.340 | | |
| Fifth | 12 | −14.447 | 0.700 | 0.700 | 1.847 | 23.8 |
| Lens | 13 | 38.234 | 1.648 | 1.648 | | |
| (Glass) | | | | | | |
| Sixth | 14 | −45.410 | 0.700 | 0.700 | 1.535 | 55.7 |
| Lens | 15 | −15.330 | 3.438 | 4.438 | | |
| Seventh | 16 | −6.948 | 1.650 | 1.650 | 1.661 | 20.4 |
| Lens | 17 | −5.352 | 0.333 | 0.333 | | |
| Eighth | 18 | −15.075 | 0.700 | 0.700 | 1.535 | 55.7 |
| Lens | 19 | 8.859 | 3.038 | 11.900 | | |
| IR-Cut | 20 | Infinity | 0.210 | 0.210 | 1.517 | 64.2 |
| Filter | 21 | Infinity | 0.399 | 0.392 | | |
| Image | Image | Infinity | 0.003 | 0.010 | | |
| Plane | | | | | | |

TABLE 2

| Surface # | 4 | 5 | 10 | 11 | 14 |
|---|---|---|---|---|---|
| Conic | 0.0000E+00 | −1.1018E+01 | 0.0000E+00 | 2.6100E+00 | 0.0000E+00 |
| Constant (K) | | | | | |
| 4th Order | −2.1218E−03 | 2.3422E−05 | −9.1641E−05 | 1.6689E−03 | 3.3384E−03 |
| Coefficient (A) | | | | | |
| 6th Order | 2.1409E−04 | 1.0183E−04 | −5.7327E−06 | −8.0401E−05 | −3.0345E−04 |
| Coefficient (B) | | | | | |
| 8th Order | −1.4269E−05 | −8.2784E−06 | −1.2174E−06 | −8.8254E−07 | −7.7288E−05 |
| Coefficient (C) | | | | | |
| 10th Order | 5.7158E−07 | 3.6807E−07 | 1.4823E−08 | −6.5702E−08 | 6.3915E−06 |
| Coefficient (D) | | | | | |
| 12th Order | −1.0094E−08 | −7.1787E−09 | −8.3185E−09 | 3.4177E−09 | −1.7987E−09 |
| Coefficient (E) | | | | | |
| Surface # | 15 | 16 | 17 | 18 | 19 |
| Conic | 0.0000E+00 | −3.6397E+01 | −1.3859E+01 | 2.7864E+01 | −4.9543E+01 |
| Constant (K) | | | | | |
| 4th Order | 3.8496E−03 | −6.7657E−03 | −7.4367E−03 | −3.0911E−02 | −2.1636E−02 |
| Coefficient (A) | | | | | |
| 6th Order | −6.5556E−05 | 4.4170E−03 | 3.3942E−03 | 1.0754E−02 | 5.8586E−03 |
| Coefficient (B) | | | | | |
| 8th Order | −1.2484E−04 | −1.4163E−03 | −1.0046E−03 | −8.3568E−03 | −3.3259E−03 |
| Coefficient (C) | | | | | |
| 10th Order | 1.4753E−05 | 2.9651E−04 | 4.3489E−04 | 6.8774E−03 | 2.2947E−03 |
| Coefficient (D) | | | | | |
| 12th Order | −4.5368E−07 | −3.5634E−05 | −2.4281E−04 | −3.8835E−03 | −1.1431E−03 |
| Coefficient (E) | | | | | |
| 14th Order | 0.0000E+00 | 2.2339E−06 | 8.0244E−05 | 1.3486E−03 | 3.5845E−04 |
| Coefficient (F) | | | | | |
| 16th Order | 0.0000E+00 | −6.0519E−08 | −1.3534E−05 | −2.7741E−04 | −6.7076E−05 |
| Coefficient (G) | | | | | |
| 18th Order | 0.0000E+00 | 0.0000E+00 | 1.1091E−06 | 3.1344E−05 | 6.8661E−06 |
| Coefficient (H) | | | | | |
| 20th Order | 0.0000E+00 | 0.0000E+00 | −3.5224E−08 | −1.5099E−06 | −2.9656E−07 |
| Coefficient (J) | | | | | |

TABLE 3

| Quantity | Wide-Angle End | Telephoto End |
|---|---|---|
| EFL (mm) | 11.2 | 26.7 |
| BFL (mm) | 3.650 | 12.512 |
| Fno | 2.52 | 4.4 |
| OAL (mm) | 34.10 | 34.10 |
| FOV (°) | 26.1 | 10.9 |

TABLE 4

| | | X Effective | Y Effective | |
|---|---|---|---|---|
| Element | Surface # | Radius (mm) | Radius (mm) | Y/X |
| First | 4 | 3.06 | 2.15 | 0.70 |
| Lens | 5 | 3.11779446 | 2.15 | 0.69 |
| Second | 6 | 3.14937749 | 2.15 | 0.68 |
| Lens | 7 | 3.12452027 | 2.15 | 0.69 |
| (Glass) | | | | |
| Third | 8 | 3.37 | 2.15 | 0.64 |
| Lens | 9 | 3.25561622 | 2.15 | 0.66 |
| (Glass) | | | | |
| Fourth | 10 | 3.1916382 | 2.15 | 0.67 |
| Lens | 11 | 2.96621571 | 2.15 | 0.72 |
| Fifth | 12 | 2.77432126 | 2.15 | 0.77 |
| Lens | 13 | 2.62823714 | 2.15 | 0.82 |
| (Glass) | | | | |
| Sixth | 14 | 2.33633722 | 2.15 | 0.92 |
| Lens | 15 | 2.28634922 | 2.15 | 0.94 |
| Seventh | 16 | 2 | 2.15 | 1.08 |
| Lens | 17 | 2.05006899 | 2.15 | 1.05 |
| Eighth | 18 | 2.03062943 | 2.15 | 1.06 |
| Lens | 19 | 2.17811504 | 2.15 | 0.99 |

### 4.2. Embodiment 2

Hereinafter, the optical imaging system 200 according to the second embodiment will be described with reference to FIGS. 5 to 8.

In an embodiment, the optical imaging system 200 may include three lens groups. The first lens group 210 may include a first lens 211 and a second lens 212, the second lens group 220 may include third to fifth lenses 221, 222, and 223, and the third lens group 230 may include a sixth lens 231 and a seventh lens 232. The second lens group 220 and the third lens group 230 may move along the optical axis in the optical axis direction. The magnification or focus of the optical imaging system 200 may be adjusted while the second lens group 220 and the third lens group 230 move along the optical axis.

The first lens group 210 may have a negative refractive power, the second lens group 220 may have a positive refractive power, and the third lens group 230 may have a negative refractive power. The focal length of the first lens group 210 may be −20.181 mm, the focal length of the second lens group 220 may be 8.95 mm, and the focal length of the third lens group 230 may be −12.682 mm.

The first lens 211 may have a negative refractive power. The object-side surface of the first lens 211 may be concave in the paraxial region. The image-side surface of the first lens 211 may be concave in the paraxial region. The object-side surface of the first lens 211 may be aspherical. The image-side surface of the first lens 211 may be aspherical. The first lens 211 may be made of plastic.

The second lens 212 may have a positive refractive power. The object-side surface of the second lens 212 may be convex in the paraxial region. The image-side surface of the second lens 212 may be concave in the paraxial region. The second lens 212 may be made of glass.

The third lens 221 may have a positive refractive power. The object-side surface of the third lens 221 may be convex in the paraxial region. The image-side surface of the third lens 221 may be convex in the paraxial region. The object-side surface of the third lens 221 may be aspherical. The image-side surface of the third lens 221 may be aspherical. The third lens 221 may be made of glass.

The fourth lens 222 may have a positive refractive power. The object-side surface of the fourth lens 222 may be convex in the paraxial region. The image-side surface of the fourth lens 222 may be convex in the paraxial region. The object-side surface of the fourth lens 222 may be aspherical. The image-side surface of the fourth lens 222 may be aspherical. The fourth lens 222 may be made of plastic.

The fifth lens 223 may have a negative refractive power. The object-side surface of the fifth lens 223 may be concave in the paraxial region. The image-side surface of the fifth lens 223 may be convex in the paraxial region. The fifth lens 223 may be made of glass.

The sixth lens 231 may have a positive refractive power. The object-side surface of the sixth lens 231 may be concave in the paraxial region. The image-side surface of the sixth lens 231 may be convex in the paraxial region. The object-side surface of the sixth lens 231 may be aspherical. The image-side surface of the sixth lens 231 may be aspherical. The sixth lens may be made of plastic.

The seventh lens 232 may have a negative refractive power. The object-side surface of the seventh lens 232 may be concave in the paraxial region. The image-side surface of the seventh lens 232 may be concave in the paraxial region. The object-side surface of the seventh lens 232 may be aspherical. The image-side surface of the seventh lens 232 may be aspherical. The seventh lens 232 may be made of plastic.

Thus, the second lens 212, the third lens 221, and the fifth lens 223 may be made of glass, and the first lens 211, the fourth lens 222, the sixth lens 231, and the seventh lens 232 may be made of plastic.

In the optical imaging system 200 according to the second embodiment, EFL_W/EFL_T may be 0.4118, vg2_1 may be 81.6, D12_T/D12_W may be 0.0944, FOV_W/FOV_T may be 2.4393, fg2/fg3 may be −0.7057, Fno_T/FOV_T may be 0.4206 (1/°), |vg_2 g−vg2_p| may be 25.9 or 31.9, |vg1_g−vg1_p| may be 32.2, MAX_GED/MIN_PED may be 1.6134, and MAX_GED/IMG_HT may be 1.2941.

Table 5 lists optical and physical parameters of the optical imaging system 200 according to the second embodiment. Table 6 lists aspheric coefficients in the second embodiment. Table 7 lists optical parameters at the wide-angle end and the telephoto end of the optical imaging system 200 according to the second embodiment. Table 8 lists the effective radius of each surface of each lens in the second embodiment.

TABLE 5

| | | | Thickness/Dis- | Thickness/Dis- | | |
|---|---|---|---|---|---|---|
| | | | tance (mm) | tance (mm) | | |
| | | | Wide-Angle | Telephoto | Refractive | Abbe |
| Element | Surface # | Ri (mm) | End | End | Index (Nd) | Number (Vi) |
| Prism | 1 | Infinity | 2.450 | 2.450 | 1.717 | 29.5 |
| | 2 | Infinity | 2.450 | 2.450 | 1.717 | 29.5 |
| | 3 | Infinity | 1.800 | 1.800 | | |
| First | 4 | −313.015 | 0.700 | 0.700 | 1.544 | 56 |
| Lens | 5 | 7.257 | 0.092 | 0.092 | | |
| Second | 6 | 9.217 | 1.000 | 1.000 | 1.847 | 23.8 |
| Lens | 7 | 12.949 | 8.475 | 0.800 | | |
| (Glass) | | | | | | |
| Third | 8 (Stop) | 5.293 | 1.852 | 1.852 | 1.497 | 81.6 |
| Lens | 9 | −84.806 | 2.130 | 2.130 | | |
| (Glass) | | | | | | |
| Fourth | 10 | 40.920 | 1.342 | 1.342 | 1.535 | 55.7 |
| Lens | 11 | −5.768 | 0.050 | 0.050 | | |
| Fifth | 12 | −7.049 | 1.929 | 1.929 | 1.847 | 23.8 |
| Lens | 13 | −21.475 | 3.383 | 2.174 | | |
| (Glass) | | | | | | |
| Sixth | 14 | −17.498 | 1.830 | 1.830 | 1.639 | 23.5 |
| Lens | 15 | −6.699 | 0.468 | 0.468 | | |
| Seventh | 16 | −7.229 | 0.700 | 0.700 | 1.535 | 55.7 |
| Lens | 17 | 8.136 | 3.226 | 12.110 | | |
| IR-Cut | 20 | Infinity | 0.210 | 0.210 | 1.517 | 64.2 |
| Filter | 21 | Infinity | 0.223 | 0.222 | | |
| Image | Image | Infinity | −0.009 | −0.008 | | |
| Plane | | | | | | |

TABLE 6

| Surface # | 4 | 5 | 8 | 9 | 10 |
|---|---|---|---|---|---|
| Conic | 0.0000E+00 | −1.1364E+01 | −7.8277E−02 | 0.0000E+00 | −9.9000E+01 |
| Constant (K) | | | | | |
| 4th Order | −3.1940E−03 | −5.7521E−05 | −2.0818E−04 | 1.3166E−04 | −1.2161E−03 |
| Coefficient (A) | | | | | |
| 6th Order | 1.9419E−04 | 1.9923E−04 | −1.1425E−06 | −3.6597E−06 | −1.5204E−04 |
| Coefficient (B) | | | | | |
| 8th Order | 3.8172E−05 | −1.1442E−04 | −1.7527E−06 | −1.2553E−06 | 1.3654E−04 |
| Coefficient (C) | | | | | |
| 10th Order | −1.8853E−05 | 4.7333E−05 | −6.1992E−08 | −1.7206E−07 | −6.5982E−05 |
| Coefficient (D) | | | | | |
| 12th Order | 4.6032E−06 | −1.1557E−05 | −2.1217E−10 | 1.4333E−08 | 2.0734E−05 |
| Coefficient (E) | | | | | |
| 14th Order | −7.2658E−07 | 1.7051E−06 | 0.0000E+00 | 0.0000E+00 | −3.9704E−06 |
| Coefficient (F) | | | | | |
| 16th Order | 7.1588E−08 | −1.5052E−07 | 0.0000E+00 | 0.0000E+00 | 4.6215E−07 |
| Coefficient (G) | | | | | |
| 18th Order | −3.9516E−09 | 7.3370E−09 | 0.0000E+00 | 0.0000E+00 | −2.9503E−08 |
| Coefficient (H) | | | | | |
| 20th Order | 9.2784E−11 | −1.5213E−10 | 0.0000E+00 | 0.0000E+00 | 8.0349E−10 |
| Coefficient (J) | | | | | |
| Surface # | 11 | 14 | 15 | 16 | 17 |
| Conic | 3.7341E−01 | −7.4710E+01 | −1.6223E+01 | −3.8411E+00 | −6.2586E+00 |
| Constant (K) | | | | | |
| 4th Order | 4.9428E−04 | −1.2705E−04 | −9.2577E−03 | −3.1796E−02 | −2.2943E−02 |
| Coefficient (A) | | | | | |
| 6th Order | −2.2731E−04 | 2.8758E−03 | 1.3350E−02 | 3.5026E−02 | 1.7703E−02 |
| Coefficient (B) | | | | | |
| 8th Order | 3.4744E−04 | −2.5049E−03 | −1.0897E−02 | −3.1700E−02 | −1.4055E−02 |
| Coefficient (C) | | | | | |
| 10th Order | −2.0163E−04 | 1.5085E−03 | 5.8054E−03 | 1.8841E−02 | 7.8434E−03 |
| Coefficient (D) | | | | | |
| 12th Order | 7.1859E−05 | −5.9459E−04 | −2.0134E−03 | −7.3062E−03 | −2.8985E−03 |
| Coefficient (E) | | | | | |
| 14th Order | −1.5699E−05 | 1.4892E−04 | 4.4507E−04 | 1.8286E−03 | 7.0077E−04 |
| Coefficient (F) | | | | | |
| 16th Order | 2.0737E−06 | −2.2660E−05 | −5.9806E−05 | −2.8324E−04 | −1.0644E−04 |
| Coefficient (G) | | | | | |
| 18th Order | −1.5170E−07 | 1.8911E−06 | 4.4143E−06 | 2.4634E−05 | 9.2142E−06 |
| Coefficient (H) | | | | | |
| 20th Order | 4.7597E−09 | −6.5494E−08 | −1.3646E−07 | −9.1930E−07 | −3.4676E−07 |
| Coefficient (J) | | | | | |

TABLE 7

| Quantity | Wide-Angle End | Telephoto End |
|---|---|---|
| EFL (mm) | 11.2 | 27.2 |
| BFL (mm) | 3.650 | 12.534 |
| Fno | 2.5 | 4.5 |
| OAL (mm) | 34.30 | 34.30 |
| FOV (°) | 26.1 | 10.7 |

TABLE 8

| | | X Effective | Y Effective | |
|---|---|---|---|---|
| Element | Surface # | Radius (mm) | Radius (mm) | Y/X |
| First | 4 | 3.03 | 2.15 | 0.71 |
| Lens | 5 | 3.07184379 | 2.15 | 0.70 |
| Second | 6 | 3.10093772 | 2.15 | 0.69 |
| Lens | 7 | 3.07278005 | 2.15 | 0.70 |
| (Glass) | | | | |
| Third | 8 | 3.3 | 2.15 | 0.65 |
| Lens | 9 | 3.2185645 | 2.15 | 0.67 |
| (Glass) | | | | |
| Fourth | 10 | 2.75238455 | 2.15 | 0.78 |
| Lens | 11 | 2.60270203 | 2.15 | 0.83 |
| Fifth | 12 | 2.5287594 | 2.15 | 0.85 |
| Lens | 13 | 2.40495104 | 2.15 | 0.89 |
| (Glass) | | | | |
| Sixth | 14 | 2.11152703 | 2.15 | 1.02 |
| Lens | 15 | 2.08780956 | 2.15 | 1.03 |
| Seventh | 16 | 2.04540447 | 2.15 | 1.05 |
| Lens | 17 | 2.35862062 | 2.15 | 0.91 |

### 4.3. Embodiment 3

Hereinafter, the optical imaging system 300 according to the third embodiment will be described with reference to FIGS. 9 to 12.

In an embodiment, the optical imaging system 300 may include three lens groups. The first lens group 310 may include a first lens 311 and a second lens 312, the second lens group 320 may include third to fifth lenses 321, 322, and 323, and the third lens group 330 may include a sixth lens 331 and a seventh lens 332. The second lens group 320 and the third lens group 330 may move along the optical axis in the optical axis direction. The magnification or focus of the optical imaging system 300 may be adjusted while the second lens group 320 and the third lens group 330 move along the optical axis.

The first lens group 310 may have a negative refractive power, the second lens group 320 may have a positive refractive power, and the third lens group 330 may have a negative refractive power. The focal length of the first lens group 310 may be −20.89 mm, the focal length of the second lens group 320 may be 8.973 mm, and the focal length of the third lens group 330 may be −13.377 mm.

The first lens 311 may have a negative refractive power. The object-side surface of the first lens 311 may be concave in the paraxial region. The image-side surface of the first lens 311 may be concave in the paraxial region. The object-side surface of the first lens 311 may be aspherical. The image-side surface of the first lens 311 may be aspherical. The first lens 311 may be made of plastic.

The second lens 312 may have a positive refractive power. The object-side surface of the second lens 312 may be convex in the paraxial region. The image-side surface of the second lens 312 may be concave in the paraxial region. The second lens 312 may be made of glass.

The third lens 321 may have a positive refractive power. The object-side surface of the third lens 321 may be convex in the paraxial region. The image-side surface of the third lens 321 may be convex in the paraxial region. The object-side surface of the third lens 321 may be aspherical. The image-side surface of the third lens 321 may be aspherical. The third lens 321 may be made of plastic.

The fourth lens 322 may have a negative refractive power. The object-side surface of the fourth lens 322 may be concave in the paraxial region. The image-side surface of the fourth lens 322 may be concave in the paraxial region. The fourth lens 322 may be made of glass.

The fifth lens 323 may have a positive refractive power. The object-side surface of the fifth lens 323 may be convex in the paraxial region. The image-side surface of the fifth lens 323 may be convex in the paraxial region. The object-side surface of the fifth lens 323 may be aspherical. The image-side surface of the fifth lens 323 may be aspherical. The fifth lens 323 may be made of plastic.

The sixth lens 331 may have a positive refractive power. The object-side surface of the sixth lens 331 may be concave in the paraxial region. The image-side surface of the sixth lens 331 may be convex in the paraxial region. The object-side surface of the sixth lens 331 may be aspherical. The image-side surface of the sixth lens 331 may be aspherical. The sixth lens 331 may be made of plastic.

The seventh lens 332 may have a negative refractive power. The object-side surface of the seventh lens 332 may be concave in the paraxial region. The image-side surface of the seventh lens 332 may be concave in the paraxial region. The object-side surface of the seventh lens 332 may be aspherical. The image-side surface of the seventh lens 332 may be aspherical. The seventh lens 332 may be made of plastic.

Thus, the second lens 312 and the fourth lens 322 may be made of glass, and the first lens 311, the third lens 321, the fifth lens 323, the sixth lens 331, and the seventh lens 332 may be made of plastic.

In the optical imaging system 300 according to the third embodiment, EFL_W/EFL_T may be 0.4133, vg2_1 may be 55.7, D12_T/D12_W may be 0.0947, FOV_W/FOV_T may be 2.4151, fg2/fg3 may be −0.6708, Fno_T/FOV_T may be 0.4811 (1/°), |vg2_g−vg2_p| may be 26.2, |vg1_g−vg1_p| may be 32.2, MAX_GED/MIN_PED may be 1.4548, and MAX_GED/IMG HT may be 1.0925.

Table 9 lists optical and physical parameters of the optical imaging system 300 according to the third embodiment. Table 10 lists aspheric coefficients in the third embodiment. Table 11 lists optical parameters at the wide-angle end and telephoto end of the optical imaging system 300 according to the third embodiment. Table 12 lists the effective radius of each surface of each lens in the third embodiment.

TABLE 9

| | | | Thickness/Dis- | Thickness/Dis- | | |
|---|---|---|---|---|---|---|
| | | | tance (mm) | tance (mm) | | |
| | | | Wide-Angle | Telephoto | Refractive | Abbe |
| Element | Surface # | Ri (mm) | End | End | Index (Nd) | Number (Vi) |
| Prism | 1 | Infinity | 2.450 | 2.450 | 1.717 | 29.5 |
| | 2 | Infinity | 2.450 | 2.450 | 1.717 | 29.5 |
| | 3 | Infinity | 1.800 | 1.800 | | |
| First | 4 | −23.191 | 0.650 | 0.650 | 1.544 | 56 |
| Lens | 5 | 11.326 | 0.100 | 0.100 | | |
| Second | 6 | 8.000 | 1.050 | 1.050 | 1.847 | 23.8 |
| Lens | 7 | 10.109 | 8.445 | 0.800 | | |
| (Glass) | | | | | | |
| Third | 8(Stop) | 4.910 | 1.850 | 1.850 | 1.535 | 55.7 |
| Lens | 9 | −19.108 | 0.646 | 0.646 | | |
| Fourth | 10 | −63.677 | 1.300 | 1.300 | 1.717 | 29.5 |
| Lens | 11 | 4.487 | 0.100 | 0.100 | | |
| (Glass) | | | | | | |
| Fifth | 12 | 5.140 | 2.000 | 2.000 | 1.535 | 55.7 |
| Lens | 13 | −12.033 | 3.931 | 2.489 | | |
| Sixth | 14 | −48.827 | 1.900 | 1.900 | 1.65 | 21.5 |
| Lens | 15 | −9.975 | 0.620 | 0.620 | | |
| Seventh | 16 | −5.546 | 0.800 | 0.800 | 1.535 | 55.7 |
| Lens | 17 | 16.299 | 3.125 | 12.210 | | |
| IR-Cut | 20 | Infinity | 0.210 | 0.210 | 1.517 | 64.2 |
| Filter | 21 | Infinity | 0.310 | 0.307 | | |
| Image | Image | Infinity | 0.006 | 0.010 | | |
| Plane | | | | | | |

TABLE 10

| Surface # | 4 | 5 | 8 | 9 | 12 |
|---|---|---|---|---|---|
| Conic | 1.0494E+01 | −3.2173E−01 | 0.0000E+00 | −2.6897E+01 | −3.9997E−01 |
| Constant (K) | | | | | |
| 4th Order | −9.6447E−05 | −5.4369E−05 | −6.6519E−04 | −2.3807E−04 | 0.0000E+00 |
| Coefficient (A) | | | | | |
| 6th Order | 1.9221E−05 | 2.3727E−05 | −1.9919E−05 | 1.8388E−05 | 1.3560E−05 |
| Coefficient (B) | | | | | |
| 8th Order | −3.4702E−07 | −4.7225E−07 | −5.6897E−07 | 1.3737E−07 | 1.8495E−05 |
| Coefficient (C) | | | | | |
| 10th Order | 0.0000E+00 | 0.0000E+00 | 0.0000E+00 | 0.0000E+00 | 4.1985E−08 |
| Coefficient (D) | | | | | |
| Surface # | 13 | 14 | 15 | 16 | 17 |
| Conic | 4.0292E+00 | −9.9000E+01 | −2.1225E+01 | −2.6130E+01 | 5.0551E+01 |
| Constant (K) | | | | | |
| 4th Order | 5.7263E−04 | 2.6802E−03 | 3.7638E−04 | −2.7036E−02 | −1.0159E−02 |
| Coefficient (A) | | | | | |
| 6th Order | −1.1704E−05 | −4.4110E−04 | −1.9093E−03 | 6.6001E−03 | 1.0659E−03 |
| Coefficient (B) | | | | | |
| 8th Order | 1.6140E−05 | 2.8823E−04 | 1.9917E−03 | −7.6605E−04 | 8.1074E−04 |
| Coefficient (C) | | | | | |
| 10th Order | 3.5287E−08 | −5.3151E−05 | −1.0327E−03 | −3.1814E−04 | −8.8164E−04 |
| Coefficient (D) | | | | | |
| 12th Order | 0.0000E+00 | −3.2323E−05 | 2.7591E−04 | 1.1389E−04 | 3.9854E−04 |
| Coefficient (E) | | | | | |
| 14th Order | 0.0000E+00 | 1.8941E−05 | −3.4049E−05 | 6.6689E−06 | −9.7744E−05 |
| Coefficient (F) | | | | | |
| 16th Order | 0.0000E+00 | −3.6685E−06 | 1.0163E−06 | −6.2765E−06 | 1.2729E−05 |
| Coefficient (G) | | | | | |
| 18th Order | 0.0000E+00 | 2.4901E−07 | 6.9122E−08 | 6.0233E−07 | −7.0446E−07 |
| Coefficient (H) | | | | | |

TABLE 11

| Quantity | Wide-Angle End | Telephoto End |
|---|---|---|
| EFL (mm) | 11.4 | 27.58 |
| BFL (mm) | 3.650 | 12.737 |
| Fno | 2.8 | 5.1 |
| OAL (mm) | 33.74 | 33.74 |
| FOV (°) | 25.6 | 10.6 |

TABLE 12

| | | X Effective | Y Effective | |
|---|---|---|---|---|
| Element | Surface # | Radius (mm) | Radius (mm) | Y/X |
| First | 4 | 2.75 | 2.15 | 0.78 |
| Lens | 5 | 2.73664837 | 2.15 | 0.79 |
| Second | 6 | 2.78578633 | 2.15 | 0.77 |
| Lens | 7 | 2.75 | 2.15 | 0.78 |
| (Glass) | | | | |
| Third | 8 | 2.94 | 2.15 | 0.73 |
| Lens | 9 | 2.82710411 | 2.15 | 0.76 |
| Fourth | 10 | 2.58361228 | 2.15 | 0.83 |
| Lens | 11 | 2.28624876 | 2.15 | 0.94 |
| (Glass) | | | | |
| Fifth | 12 | 2.2891875 | 2.15 | 0.94 |
| Lens | 13 | 2.2 | 2.15 | 0.98 |
| Sixth | 14 | 1.95 | 2.15 | 1.10 |
| Lens | 15 | 1.95591295 | 2.15 | 1.10 |
| Seventh | 16 | 1.91490402 | 2.15 | 1.12 |
| Lens | 17 | 2.03056226 | 2.15 | 1.06 |

### 4.4. Embodiment 4

Hereinafter, the optical imaging system 400 according to the fourth embodiment will be described with reference to FIGS. 13 to 16.

In an embodiment, the optical imaging system 400 may include three lens groups. The first lens group 410 may include first to third lenses 411, 412, and 413, the second lens group 420 may include fourth to sixth lenses 421, 422, and 423, and the third lens group 430 may include a seventh lens 431 and an eighth lens 432. The second lens group 420 and the third lens group 430 may move along the optical axis in the optical axis direction. The magnification or focus of the optical imaging system 400 may be adjusted while the second lens group 420 and the third lens group 430 move along the optical axis.

The first lens group 410 may have a negative refractive power, the second lens group 420 may have a positive refractive power, and the third lens group 430 may have a negative refractive power. The focal length of the first lens group 410 may be −20.952 mm, the focal length of the second lens group 420 may be 7.64 mm, and the focal length of the third lens group 430 may be −12.955 mm.

The first lens 411 may have a positive refractive power. The object-side surface of the first lens 411 may be convex in the paraxial region. The image-side surface of the first lens 411 may be convex in the paraxial region. The first lens 411 may be made of glass.

The second lens 412 may have a negative refractive power. The object-side surface of the second lens 412 may be concave in the paraxial region. The image-side surface of the second lens 412 may be concave in the paraxial region. The object-side surface of the second lens 412 may be aspherical. The image-side surface of the second lens 412 may be aspherical. The second lens 412 may be made of plastic.

The third lens 413 may have a negative refractive power. The object-side surface of the third lens 413 may be convex in the paraxial region. The image-side surface of the third lens 413 may be concave in the paraxial region. The object-side surface of the third lens 413 may be aspherical. The image-side surface of the third lens 413 may be aspherical. The third lens 413 may be made of plastic.

The fourth lens 421 may have a positive refractive power. The object-side surface of the fourth lens 421 may be convex in the paraxial region. The image-side surface of the fourth lens 421 may be convex in the paraxial region. The object-side surface of the fourth lens 421 may be aspherical. The image-side surface of the fourth lens 421 may be aspherical. The fourth lens 421 may be made of plastic.

The fifth lens 422 may have a negative refractive power. The object-side surface of the fifth lens 422 may be concave in the paraxial region. The image-side surface of the fifth lens 422 may be concave in the paraxial region. The fifth lens 422 may be made of glass.

The sixth lens 423 may have a positive refractive power. The object-side surface of the sixth lens 423 may be convex in the paraxial region. The image-side surface of the sixth lens 423 may be convex in the paraxial region. The object-side surface of the sixth lens 423 may be aspherical. The image-side surface of the sixth lens 423 may be aspherical. The sixth lens 423 may be made of plastic.

The seventh lens 431 may have a positive refractive power. The object-side surface of the seventh lens 431 may be concave in the paraxial region. The image-side surface of the seventh lens 431 may be convex in the paraxial region. The object-side surface of the seventh lens 431 may be aspherical. The image-side surface of the seventh lens 431 may be aspherical. The seventh lens 431 may be made of plastic.

The eighth lens 432 may have a negative refractive power. The object-side surface of the eighth lens 432 may be concave in the paraxial region. The image-side surface of the eighth lens 432 may be concave in the paraxial region. The object-side surface of the eighth lens 432 may be aspherical. The image-side surface of the eighth lens 432 may be aspherical. The eighth lens 432 may be made of plastic.

Thus, the first lens 411 and the fifth lens 422 may be made of glass, and the second lens 412, the third lens 413, the fourth lens 421, the sixth lens 421, the seventh lens 431, and the eighth lens 432 may be made of plastic.

In the optical imaging system 400 according to the fourth embodiment, EFL_W/EFL_T may be 0.4118, vg2_1 may be 55.7, D12_T/D12_W may be 0.1097, FOV_W/FOV_T may be 2.4486, fg2/fg3 may be −0.5897, Fno_T/FOV_T may be 0.4093 (1/°), |vg2_g−vg2_p| may be 28.2, |vg1_g−vg1_p| may be 13.2 or 12.9, MAX_GED/MIN_PED may be 1.4889, and MAX_GED/IMG HT may be 1.2157.

Table 13 lists optical and physical parameters of the optical imaging system 400 according to the fourth embodiment. Table 14 lists aspheric coefficients in the fourth embodiment. Table 15 lists optical parameters at the wide-angle end and the telephoto end of the optical imaging system 400 according to the fourth embodiment. Table 16 lists the effective radius of each surface of each lens in the fourth embodiment.

TABLE 13

| | | | Thickness/Dis- | Thickness/Dis- | | |
|---|---|---|---|---|---|---|
| | | | tance (mm) | tance (mm) | | |
| | | | Wide-Angle | Telephoto | Refractive | Abbe |
| Element | Surface # | Ri (mm) | End | End | Index (Nd) | Number (Vi) |
| Prism | 1 | Infinity | 2.450 | 2.450 | 1.717 | 29.5 |
| | 2 | Infinity | 2.450 | 2.450 | 1.717 | 29.5 |
| | 3 | Infinity | 1.800 | 1.800 | | |
| First | 4 | 22.098 | 1.017 | 1.017 | 1.567 | 42.8 |
| Lens | 5 | −13.978 | 0.700 | 0.700 | | |
| (Glass) | | | | | | |
| Second | 6 | −29.632 | 1.049 | 1.049 | 1.544 | 56 |
| Lens | 7 | 24.084 | 0.463 | 0.463 | | |
| Third | 8 | 12.999 | 1.200 | 1.200 | 1.535 | 55.7 |
| Lens | 9 | 4.005 | 8.701 | 1.400 | | |
| Stop | — | Infinity | −0.500 | −0.500 | | |
| Fourth | 10 | 4.719 | 1.790 | 1.790 | 1.535 | 55.7 |
| Lens | 11 | −9.864 | 0.350 | 0.350 | | |
| Fifth | 12 | −182.999 | 0.700 | 0.700 | 1.755 | 27.5 |
| Lens | 13 | 5.483 | 0.386 | 0.386 | | |
| (Glass) | | | | | | |
| Sixth | 14 | 7.413 | 1.982 | 1.982 | 1.535 | 55.7 |
| Lens | 15 | −12.982 | 3.383 | 2.050 | | |
| Seventh | 16 | −8.706 | 1.900 | 1.900 | 1.635 | 24 |
| Lens | 17 | −4.734 | 0.205 | 0.205 | | |
| Eighth | 18 | −7.413 | 1.024 | 1.024 | 1.535 | 55.7 |
| Lens | 19 | 7.898 | 3.080 | 11.715 | | |
| IR-Cut | 20 | Infinity | 0.210 | 0.210 | 1.517 | 64.2 |
| Filter | 21 | Infinity | 0.168 | 0.156 | | |
| Image | Image | Infinity | −0.008 | 0.003 | | |
| Plane | | | | | | |

TABLE 14

| Surface # | 6 | 7 | 8 | 9 | 10 | 11 |
|---|---|---|---|---|---|---|
| Conic | 5.8142E+01 | −7.3063E+01 | 1.4863E+01 | −1.1354E−01 | 8.1895E−02 | −2.2490E+00 |
| Constant (K) | | | | | | |
| 4th Order | 3.4262E−04 | 3.6601E−03 | −4.2381E−03 | −9.6909E−03 | −4.2286E−04 | 2.8490E−03 |
| Coefficient (A) | | | | | | |
| 6th Order | −4.6526E−04 | −1.5314E−03 | −6.1866E−04 | 6.3268E−04 | −4.3047E−05 | −2.0897E−04 |
| Coefficient (B) | | | | | | |
| 8th Order | 5.7825E−05 | 2.2670E−04 | 1.6519E−04 | −2.6697E−05 | 6.3902E−06 | −2.8052E−06 |
| Coefficient (C) | | | | | | |
| 10th Order | −2.3652E−06 | −1.0765E−05 | −9.8905E−06 | 0.0000E+00 | −1.5498E−06 | 0.0000E+00 |
| Coefficient (D) | | | | | | |
| Surface # | 14 | 15 | 16 | 17 | 18 | 19 |
| Conic | −7.6023E+00 | 1.9704E+01 | −2.0733E+01 | 5.2196E−01 | −3.5568E+00 | −1.8667E+01 |
| Constant (K) | | | | | | |
| 4th Order | 4.3888E−03 | 1.9857E−03 | 1.8815E−03 | 5.3264E−03 | −2.0338E−02 | −1.4838E−02 |
| Coefficient (A) | | | | | | |
| 6th Order | −4.7433E−05 | 3.6071E−04 | −1.3948E−06 | −7.1238E−04 | 1.8501E−03 | 2.9239E−03 |
| Coefficient (B) | | | | | | |
| 8th Order | −1.0384E−04 | −1.0342E−04 | 1.8394E−05 | 1.5602E−04 | 0.0000E+00 | −3.8055E−04 |
| Coefficient (C) | | | | | | |
| 10th Order | 1.1936E−05 | 1.3405E−05 | 0.0000E+00 | −4.0313E−06 | 0.0000E+00 | 3.5814E−05 |
| Coefficient (D) | | | | | | |
| 12th Order | 0.0000E+00 | 0.0000E+00 | 0.0000E+00 | 0.0000E+00 | 0.0000E+00 | −1.4606E−06 |
| Coefficient (E) | | | | | | |

TABLE 15

| Quantity | Wide-Angle End | Telephoto End |
|---|---|---|
| EFL (mm) | 11.2 | 27.2 |
| BFL (mm) | 3.450 | 12.084 |
| Fno | 2.42 | 4.38 |
| OAL (mm) | 34.50 | 34.50 |
| FOV (°) | 26.2 | 10.7 |

TABLE 16

| | | X Effective | Y Effective | |
|---|---|---|---|---|
| Element | Surface # | Radius (mm) | Radius (mm) | Y/X |
| First | 4 | 3.1 | 2.15 | 0.69 |
| Lens | 5 | 3.07838528 | 2.15 | 0.70 |
| (Glass) | | | | |
| Second | 6 | 2.90684646 | 2.15 | 0.74 |
| Lens | 7 | 2.83645305 | 2.15 | 0.76 |
| Third | 8 | 2.83445695 | 2.15 | 0.76 |
| Lens | 9 | 2.74020034 | 2.15 | 0.78 |
| Fourth | 10 | 2.96949191 | 2.15 | 0.72 |
| Lens | 11 | 2.91681943 | 2.15 | 0.74 |
| Fifth | 12 | 2.66063101 | 2.15 | 0.81 |
| Lens | 13 | 2.41751617 | 2.15 | 0.89 |
| (Glass) | | | | |
| Sixth | 14 | 2.42889615 | 2.15 | 0.89 |
| Lens | 15 | 2.3 | 2.15 | 0.93 |
| Seventh | 16 | 2.1 | 2.15 | 1.02 |
| Lens | 17 | 2.10469194 | 2.15 | 1.02 |
| Eighth | 18 | 2.08213973 | 2.15 | 1.03 |
| Lens | 19 | 2.19378 | 2.15 | 0.98 |

### 4.5. Embodiment 5

Hereinafter, the optical imaging system 500 according to the fifth embodiment will be described with reference to FIGS. 17 to 20.

In an embodiment, the optical imaging system 500 may include three lens groups. The first lens group 510 may include a first lens 511 and a second lens 512, the second lens group 520 may include third to sixth lenses 521, 522, 523, and 524, and the third lens group 530 may include a seventh lens 531 and an eighth lens 532. The second lens group 520 and the third lens group 530 may move along the optical axis in the optical axis direction. The magnification or focus of the optical imaging system 500 may be adjusted while the second lens group 520 and the third lens group 530 move along the optical axis.

The first lens group 510 may have a negative refractive power, the second lens group 520 may have a positive refractive power, and the third lens group 530 may have a negative refractive power. The focal length of the first lens group 510 may be −19.968 mm, the focal length of the second lens group 520 may be 9.1 mm, and the focal length of the third lens group 530 may be −12.969 mm.

The first lens 511 may have a negative refractive power. The object-side surface of the first lens 511 may be concave in the paraxial region. The image-side surface of the first lens 511 may be concave in the paraxial region. The object-side surface of the first lens 511 may be aspherical. The image-side surface of the first lens 511 may be aspherical. The first lens 511 may be made of plastic.

The second lens 512 may have a positive refractive power. The object-side surface of the second lens 512 may be convex in the paraxial region. The image-side surface of the second lens 512 may be concave in the paraxial region. The second lens 512 may be made of glass.

The third lens 521 may have a positive refractive power. The object-side surface of the third lens 521 may be convex in the paraxial region. The image-side surface of the third lens 521 may be convex in the paraxial region. The third lens 521 may be made of glass.

The fourth lens 522 may have a positive refractive power. The object-side surface of the fourth lens 522 may be convex in the paraxial region. The image-side surface of the fourth lens 522 may be convex in the paraxial region. The object-side surface of the fourth lens 522 may be aspherical. The image-side surface of the fourth lens 522 may be aspherical. The fourth lens 522 may be made of plastic.

The fifth lens 523 may have a negative refractive power. The object-side surface of the fifth lens 523 may be concave in the paraxial region. The image-side surface of the fifth lens 523 may be convex in the paraxial region. The fifth lens 523 may be made of glass.

The sixth lens 524 may have a positive refractive power. The object-side surface of the sixth lens 524 may be concave in the paraxial region. The image-side surface of the sixth lens 524 may be convex in the paraxial region. The object-side surface of the sixth lens 524 may be aspherical. The image-side surface of the sixth lens 524 may be aspherical. The sixth lens 524 may be made of plastic.

The seventh lens 531 may have a positive refractive power. The object-side surface of the seventh lens 531 may be concave in the paraxial region. The image-side surface of the seventh lens 531 may be convex in the paraxial region. The object-side surface of the seventh lens 531 may be aspherical. The image-side surface of the seventh lens 531 may be aspherical. The seventh lens 531 may be made of plastic.

The eighth lens 532 may have a negative refractive power. The object-side surface of the eighth lens 532 may be concave in the paraxial region. The image-side surface of the eighth lens 532 may be concave in the paraxial region. The object-side surface of the eighth lens 532 may be aspherical. The image-side surface of the eighth lens 532 may be aspherical. The eighth lens 532 may be made of plastic.

Thus, the second lens 512, the third lens 521, and the fifth lens 523 may be made of glass, and the first lens 511, the fourth lens 522, the sixth lens 524, the seventh lens 531, and the eighth lens 532 may be made of plastic.

In the optical imaging system 500 according to the fifth embodiment, EFL_W/EFL_T may be 0.4195, vg2_1 may be 81.6, D12_T/D12_W may be 0.0944, FOV_W/FOV_T may be 2.3945, fg2/fg3 may be −0.7017, Fno_T/FOV_T may be 0.4009 (1/°), |vg2_g−vg2_p| may be 25.9 or 31.9, |vg1_g−vg1_p| may be 32.2, MAX_GED/MIN_PED may be 1.6383, and MAX_GED/IMG HT may be 1.3137.

Table 17 lists optical and physical parameters of the optical imaging system 500 according to the fifth embodiment. Table 18 lists aspheric coefficients in the fifth embodiment. Table 19 lists optical parameters at the wide-angle end and the telephoto end of the optical imaging system 500 according to the fifth embodiment. Table 20 lists the effective radius of each surface of each lens in the fifth embodiment.

TABLE 17

| | | | Thickness/Dis- | Thickness/Dis- | | |
|---|---|---|---|---|---|---|
| | | | tance (mm) | tance (mm) | | |
| | | | Wide-Angle | Telephoto | Refractive | Abbe |
| Element | Surface # | Ri (mm) | End | End | Index (Nd) | Number (Vi) |
| Prism | 1 | Infinity | 2.450 | 2.450 | 1.717 | 29.5 |
| | 2 | Infinity | 2.450 | 2.450 | 1.717 | 29.5 |
| | 3 | Infinity | 1.800 | 1.800 | | |
| First | 4 | −220.690 | 0.700 | 0.700 | 1.544 | 56 |
| Lens | 5 | 7.248 | 0.074 | 0.074 | | |
| Second | 6 | 8.787 | 1.000 | 1.000 | 1.847 | 23.8 |
| Lens | 7 | 12.146 | 8.471 | 0.800 | | |
| (Glass) | | | | | | |
| Third | 8(Stop) | 5.621 | 1.877 | 1.877 | 1.497 | 81.6 |
| Lens | 9 | −77.870 | 1.052 | 1.052 | | |
| (Glass) | | | | | | |
| Fourth | 10 | 25.255 | 0.997 | 0.997 | 1.535 | 55.7 |
| Lens | 11 | −10.788 | 0.144 | 0.144 | | |
| Fifth | 12 | −11.760 | 0.700 | 0.700 | 1.847 | 23.8 |
| Lens | 13 | −500.000 | 1.900 | 1.900 | | |
| (Glass) | | | | | | |
| Sixth | 14 | −9.235 | 0.700 | 0.700 | 1.535 | 55.7 |
| Lens | 15 | −5.932 | 3.421 | 2.232 | | |
| Seventh | 16 | −12.943 | 1.650 | 1.650 | 1.639 | 23.5 |
| Lens | 17 | −6.640 | 0.426 | 0.426 | | |
| Eighth | 18 | −9.320 | 0.838 | 0.838 | 1.535 | 55.7 |
| Lens | 19 | 7.908 | 3.040 | 11.900 | | |
| IR-Cut | 20 | Infinity | 0.210 | 0.210 | 1.517 | 64.2 |
| Filter | 21 | Infinity | 0.402 | 0.392 | | |
| Image | Image | Infinity | −0.002 | 0.010 | | |
| Plane | | | | | | |

TABLE 18

| Surface # | 4 | 5 | 10 | 11 | 14 |
|---|---|---|---|---|---|
| Conic | 0.0000E+00 | −1.0637E+01 | 0.0000E+00 | 1.5425E+00 | 0.0000E+00 |
| Constant (K) | | | | | |
| 4th Order | −3.1864E−03 | −4.2570E−05 | −1.0499E−03 | 6.3472E−04 | 2.5577E−04 |
| Coefficient (A) | | | | | |
| 6th Order | 2.9840E−04 | 8.2883E−05 | 1.0700E−04 | 2.1007E−04 | 5.4514E−04 |
| Coefficient (B) | | | | | |
| 8th Order | −1.8465E−05 | −3.7715E−06 | −7.9781E−06 | −2.5990E−05 | −1.5142E−04 |
| Coefficient (C) | | | | | |
| 10th Order | 6.5651E−07 | −6.4830E−09 | 4.5696E−07 | 1.7382E−06 | 1.1847E−05 |
| Coefficient (D) | | | | | |
| 12th Order | −9.2524E−09 | 4.4252E−09 | −9.5317E−09 | −4.8686E−08 | −3.8940E−07 |
| Coefficient (E) | | | | | |
| Surface # | 15 | 16 | 17 | 18 | 19 |
| Conic | 0.0000E+00 | −7.7398E+01 | −1.6569E+01 | −3.6061E−01 | −1.3709E+01 |
| Constant (K) | | | | | |
| 4th Order | 5.8834E−04 | −1.6283E−03 | −9.5998E−03 | −3.0788E−02 | −2.0736E−02 |
| Coefficient (A) | | | | | |
| 6th Order | 5.4551E−04 | 2.4620E−03 | 1.0268E−02 | 2.4235E−02 | 1.2336E−02 |
| Coefficient (B) | | | | | |
| 8th Order | −1.3987E−04 | −8.9154E−04 | −6.0581E−03 | −1.7368E−02 | −8.3004E−03 |
| Coefficient (C) | | | | | |
| 10th Order | 1.1495E−05 | 2.1457E−04 | 2.5819E−03 | 9.0472E−03 | 4.3246E−03 |
| Coefficient (D) | | | | | |
| 12th Order | −3.7613E−07 | −3.3964E−05 | −8.0240E−04 | −3.3416E−03 | −1.5852E−03 |
| Coefficient (E) | | | | | |
| 14th Order | 0.0000E+00 | 3.2637E−06 | 1.7032E−04 | 8.3658E−04 | 3.9218E−04 |
| Coefficient (F) | | | | | |
| 16th Order | 0.0000E+00 | −1.4549E−07 | −2.2511E−05 | −1.3247E−04 | −6.1619E−05 |
| Coefficient (G) | | | | | |
| 18th Order | 0.0000E+00 | 0.0000E+00 | 1.6341E−06 | 1.1885E−05 | 5.5208E−06 |
| Coefficient (H) | | | | | |
| 20th Order | 0.0000E+00 | 0.0000E+00 | −4.9259E−08 | −4.6030E−07 | −2.1425E−07 |
| Coefficient (J) | | | | | |

TABLE 19

| Quantity | Wide-Angle End | Telephoto End |
|---|---|---|
| EFL (mm) | 11.2 | 26.7 |
| BFL (mm) | 3.650 | 12.512 |
| Fno | 2.47 | 4.37 |
| OAL (mm) | 34.30 | 34.30 |
| FOV (°) | 26.1 | 10.9 |

TABLE 20

| | | X Effective | Y Effective | |
|---|---|---|---|---|
| Element | Surface # | Radius (mm) | Radius (mm) | Y/X |
| First | 4 | 3.06 | 2.15 | 0.70 |
| Lens | 5 | 3.12070028 | 2.15 | 0.69 |
| Second | 6 | 3.15192101 | 2.15 | 0.68 |
| Lens | 7 | 3.11782322 | 2.15 | 0.69 |
| (Glass) | | | | |
| Third | 8 | 3.35 | 2.15 | 0.64 |
| Lens | 9 | 3.25130522 | 2.15 | 0.66 |
| (Glass) | | | | |
| Fourth | 10 | 2.95656963 | 2.15 | 0.73 |
| Lens | 11 | 2.8565422 | 2.15 | 0.75 |
| Fifth | 12 | 2.81363433 | 2.15 | 0.76 |
| Lens | 13 | 2.73789793 | 2.15 | 0.79 |
| (Glass) | | | | |
| Sixth | 14 | 2.52391083 | 2.15 | 0.85 |
| Lens | 15 | 2.54481513 | 2.15 | 0.84 |
| Seventh | 16 | 2.1 | 2.15 | 1.02 |
| Lens | 17 | 2.08086764 | 2.15 | 1.03 |
| Eighth | 18 | 2.04475647 | 2.15 | 1.05 |
| Lens | 19 | 2.13875787 | 2.15 | 1.01 |

Table 21 lists the values of various quantities and Conditional Expressions 1 and 3-10 in the optical imaging systems 100, 200, 300, 400, and 500 according to the first to fifth embodiments.

TABLE 21

| Quantity | Emb. 1 | Emb. 2 | Emb. 3 | Emb. 4 | Emb. 5 |
|---|---|---|---|---|---|
| EFL_W (mm) | 11.2 | 11.2 | 11.4 | 11.2 | 11.2 |
| EFL_T (mm) | 26.7 | 27.2 | 27.58 | 27.2 | 26.7 |
| BFL_W (mm) | 3.650 | 3.650 | 3.650 | 3.450 | 3.650 |
| BFL_T (mm) | 12.512 | 12.534 | 12.737 | 12.084 | 12.512 |
| Fno_W | 2.52 | 2.5 | 2.8 | 2.42 | 2.47 |
| Fno_T | 4.4 | 4.5 | 5.1 | 4.38 | 4.37 |
| OAL_W (mm) | 34.10 | 34.30 | 33.74 | 34.50 | 34.30 |
| OAL_T (mm) | 34.10 | 34.30 | 33.74 | 34.50 | 34.30 |
| FOV_W (°) | 26.1 | 26.1 | 25.6 | 26.2 | 26.1 |
| FOV_T(°) | 10.9 | 10.7 | 10.6 | 10.7 | 10.9 |
| fg1 (mm) | −19.153 | −20.181 | −20.89 | −20.952 | −19.968 |
| fg2 (mm) | 8.789 | 8.95 | 8.973 | 7.64 | 9.1 |
| fg3 (mm) | −15.749 | −12.682 | −13.377 | −12.955 | −12.969 |
| D12_W (mm) | 8.663 | 8.475 | 8.445 | 8.201 | 8.471 |
| D12_T (mm) | 0.800 | 0.800 | 0.800 | 0.900 | 0.800 |
| vg2_1 | 81.6 | 81.6 | 55.7 | 55.7 | 81.6 |
| vg1_g | 23.8 | 23.8 | 23.8 | 42.8 | 23.8 |
| vg1_p | 56 | 56 | 56 | 56 | 56 |
| | — | — | — | 55.7 | — |
| vg2_g | 81.6 | 81.6 | 29.5 | 27.5 | 81.6 |
| | 23.8 | 23.8 | — | — | 23.8 |
| vg2_p | 55.7 | 55.7 | 55.7 | 55.7 | 55.7 |
| | 55.7 | — | 55.7 | 55.7 | 55.7 |
| MAX_GED (mm) | 3.37 | 3.3 | 2.78578633 | 3.1 | 3.35 |
| MIN_PED (mm) | 2 | 2.04540447 | 1.91490402 | 2.08213973 | 2.04475647 |
| IMG HT (mm) | 2.55 | 2.55 | 2.55 | 2.55 | 2.55 |
| EFL_W/EFL_T | 0.4195 | 0.4118 | 0.4133 | 0.4118 | 0.4195 |
| D12_T/D12_W | 0.0924 | 0.0944 | 0.0947 | 0.1097 | 0.0944 |
| FOV_W/FOV_T | 2.3945 | 2.4393 | 2.4151 | 2.4486 | 2.3945 |
| fg2/fg3 | −0.5581 | −0.7057 | −0.6708 | −0.5897 | −0.7017 |
| Fno_T/FOV_T (1/°) | 0.4037 | 0.4206 | 0.4811 | 0.4093 | 0.4009 |
| \|vg2_g-vg2_p\| | 25.9 | 25.9 | 26.2 | 28.2 | 25.9 |
| | 25.9 | — | 26.2 | 28.2 | 25.9 |
| | 31.9 | 31.9 | — | — | 31.9 |
| | 31.9 | — | — | — | 31.9 |
| \|vg1_g-vg1_p\| | 32.2 | 32.2 | 32.2 | 13.2 | 32.2 |
| | — | — | — | 12.9 | — |
| MAX_GED/MIN PED | 1.685 | 1.6134 | 1.4548 | 1.4889 | 1.6383 |
| MAX_GED/IMG HT | 1.3216 | 1.2941 | 1.0925 | 1.2157 | 1.3137 |

According to the aforementioned embodiments, the optical imaging system may, by changing the focal length, implement the optical zoom function, and may reduce degradation of an image quality.

While this disclosure includes specific examples, it will be apparent after an understanding of the disclosure of this application that various changes in form and detail may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group comprising at least one lens;
a second lens group comprising at least one lens; and
a third lens group comprising at least one lens,
wherein the first lens group, the second lens group, and the third lens group are sequentially disposed in ascending numerical order along an optical axis of the optical imaging system from an object side of the optical imaging system toward an image plane of the optical imaging system,
each of the second lens group and the third lens group is configured to move along the optical axis relative to the first lens group,
the at least one lens of the second lens group comprises at least one glass lens and at least one plastic lens, and
an Abbe number of a glass lens of the at least one glass lens of the second lens group is vg2_g, an Abbe number of a plastic lens of the at least one plastic lens of the second lens group is vg2_p, and |vg2_g−vg2_p| is greater than 25.

2. The optical imaging system of claim 1, wherein each plastic lens of the at least one plastic lens of the second lens group is an aspherical lens, and each glass lens of the at least one glass lens of the second lens group is a spherical lens.

3. The optical imaging system of claim 1, wherein each lens of the first to third lens groups has a length in a first axial direction perpendicular to the optical axis, and a length in a second axial direction perpendicular to both the optical axis and the first axial direction that is longer than the length in the first axial direction.

4. The optical imaging system of claim 1, further comprising an optical path changing element P disposed on an object side of the first lens group and configured to change a path of light passing through the optical imaging system.

5. The optical imaging system of claim 4, wherein an effective focal length of the optical imaging system at a telephoto end of the optical imaging system is EFL_T, an effective focal length of the optical imaging system at a wide-angle end of the optical imaging system is EFL_W, and EFL_W/EFL_T is less than 0.7.

6. The optical imaging system of claim 1, wherein the at least one lens of the second lens group is a plurality of lenses, and
an Abbe number of a lens closest to the object side of the optical imaging system among the plurality of lenses of the second lens group is vg2_1, and vg2_1 is greater than 55.

7. The optical imaging system of claim 1, wherein a spacing distance on the optical axis between the first lens group and the second lens group at a wide-angle end of the optical imaging system is D12_W, a spacing distance on the optical axis between the first lens group and the second lens group at a telephoto end of the optical imaging system is D12_T, and D12_T/D12_W is less than 0.3.

8. The optical imaging system of claim 1, wherein a field of view at a telephoto end of the optical imaging system is FOV_T, a field of view at a wide-angle end of the optical imaging system is FOV_W, and FOV_W/FOV_T is greater than 1.6.

9. The optical imaging system of claim 1, wherein a focal length of the second lens group is fg2, a focal length of the third lens group is fg3, and fg2/fg3 is greater than −0.8.

10. The optical imaging system of claim 1, wherein an F number of the optical imaging system at a telephoto end of the optical imaging system is Fno_T, a field of view of the optical imaging system at a telephoto end of the optical imaging system is FOV_T, and Fno_T/FOV_T is less than 0.5 (1/°).

11. The optical imaging system of claim 1, wherein the at least one lens of the first lens group comprises at least one glass lens and at least one plastic lens,
the at least one lens of the third lens group comprises at least one plastic lens, and an effective radius of a glass lens having a largest effective radius among the glass lenses of the first and second lens groups is MAX_GED, an effective radius of a plastic lens having a smallest effective radius among the plastic lenses of the first to third lens groups is MIN_PED, and MAX_GED/MIN_PED is greater than 1 and less than 1.7.

12. The optical imaging system of claim 1, wherein the at least one lens of the first lens group comprises at least one glass lens and at least one plastic lens, and
an effective radius of a glass lens having a largest effective radius among the glass lenses of the first and second lens groups is MAX_GED, one half of a diagonal length of the image plane of the optical imaging system is IMG_HT, and MAX_GED/IMG_HT is greater than 1 and less than 1.4.

13. The optical imaging system of claim 1, further comprising a stop disposed between the first lens group and the second lens group.

14. The optical imaging system of claim 13, wherein the at least one lens of the second lens group is a plurality of lenses, and
a lens disposed closest to the stop among the plurality of lenses of the second lens group has an effective radius that is larger than an effective radius of each other lens of the first to third lens groups.

15. The optical imaging system of claim 1, wherein the first lens group has a negative refractive power, the second lens group has a positive refractive power, and the third lens group has a negative refractive power.

16. The optical imaging system of claim 1, wherein the at least one lens of the second lens group is a plurality of lenses, and
among the plurality of lenses of the second lens group, a lens closest to the object side of the optical imaging system has a positive refractive power.

17. The optical imaging system of claim 16, wherein the at least one lens of the third lens group comprises a lens having a positive refractive power disposed closest to the object side of the optical imaging system among the plurality of lenses of the third lens group, and a lens having a negative refractive power disposed closest to the image side of the optical imaging system among the plurality of lenses of the third lens group.

18. An optical imaging system comprising:
a first lens group comprising a plurality of lenses and having a negative refractive power;
a second lens group comprising a plurality of lenses and having a positive refractive power; and
a third lens group comprising a plurality of lenses and having a negative refractive power,
wherein the first lens group, the second lens group, and the third lens group are sequentially disposed in ascending numerical order along an optical axis of the optical imaging system from an object side of the optical imaging system toward an image side of the optical imaging system,
each of the second lens group and the third lens group is configured to move along the optical axis relative to the first lens group,
the optical imaging system further comprises a stop disposed between the first lens group and the second lens group,
the at least one lens of the second lens group comprises at least one glass lens and at least one plastic lens, and
a glass lens of the at least one glass lens of the second lens group has a length in a first axial direction perpendicular to the optical axis, and a length in a second axial direction perpendicular to both the optical axis and the first axial direction that is longer than the length in the first axial direction.

19. The optical imaging system of claim 18, wherein an Abbe number of a glass lens of the at least one glass lens of the second lens group is vg2_g, an Abbe number of a plastic lens of the at least one plastic lens of the second lens group is vg2_p, and |vg2_g−vg2_p| is greater than 25 and less than 35.

20. The optical imaging system of claim 18, wherein the at least one lens of the first lens group comprises at least one glass lens and at least one plastic lens.

21. The optical imaging system of claim 20, wherein an Abbe number of a glass lens of the at least one glass lens of the first lens group is vg1_g, an Abbe number of a plastic lens of the at least one plastic lens of the first lens group is vg1_p, and |vg1_g−vg1_p| is greater than 30.
